(19) United States
(12) Patent Application Publication
(10) Pub. No.: US 2010/0098949 A1
(43) Pub. Date: Apr. 22, 2010

(54) ANTIMICROBIAL ARTICLES AND METHOD OF MANUFACTURE

(76) Inventors: Scott A. Burton, Woodbury, MN (US); David R. Holm, Hudson, WI (US)

Correspondence Address: 3M INNOVATIVE PROPERTIES COMPANY, PO BOX 33427, ST. PAUL, MN, 55133-3427, US

(21) Appl. No.: 12/444,877

(22) PCT Filed: Oct. 16, 2007
(86) PCT No.: PCT/US07/81477

§ 371 Date: Apr. 9, 2009

Related U.S. Application Data
(60) Provisional application No. 60/966,531, filed on Oct. 18, 2006.

(30) Foreign Application Priority Data
Oct. 18, 2006 (US) 10550440

(51) Int. Cl. B32B 9/04; B05D 3/02; B32B 27/34; B32B 27/06; B32B 27/36; B32B 27/30; B32B 27/32; B32B 27/40; B32B 17/06; B32B 18/00; B32B 29/00; B32B 23/04; B32B 25/12; B32B 25/04

(52) U.S. Cl. 428/412; 427/372.2; 428/474.4; 428/477.7; 428/480; 428/522; 428/523; 428/425.9; 428/421; 428/422; 428/432; 428/446; 428/689; 428/704; 428/532; 428/475.5; 428/492

(57) ABSTRACT

Antimicrobial articles and methods for the manufacture of such articles are provided.

The present invention relates to antimicrobial articles comprising silver and to methods for the manufacture of such articles.

### BACKGROUND

While skin wounds heal more effectively in moist environments, the risk of a bacterial infection increases in the presence of moisture. Moreover, bacteria can build a resistance to antibiotics, eventually rendering an antibiotic ineffective. Silver compounds are known to impart antimicrobial effects to a surface (e.g., wound tissue) with minimal risk of developing bacterial resistance. In the moist environment of a wound bed, for example, silver is delivered by the sustained release of silver ions into the wound.

The literature has reported that silver salts coated on cotton or other substrates, in the absence of stabilizers, are not color stable upon exposure to ultraviolet (“UV”) or visible light. However, stabilizers also reduce the solubility of the silver salts which also inhibits the release of silver ions. If the release of silver ions is too low (less than 0.01 mg/g dressing in water in 30 minutes) its antimicrobial action will also be reduced and it may no longer be efficacious for the treatment of a wound.

It is desirable to provide color stable antimicrobial articles and methods for the manufacture of such articles wherein the articles provide antimicrobial activity when used as wound dressings or the like.

### SUMMARY

The present invention provides articles and methods for the manufacture of such articles.

In an aspect of the invention, a method of making an antimicrobial article is provided, the method comprising: applying a silver composition to a substrate to provide a liquid coated substrate, the silver composition comprising a silver salt other than silver sulfate in a solvent, the silver composition comprising stabilizing agent in an amount less than about 100 parts per million (ppm); the substrate comprising material selected from the group consisting of polyamide, polyester, polyacetate, polyacrylic, polyolefin, polyurethane, polyvinylchloride, polyvinyl alcohol, polycarbonate, polyvinylpyrrolidone, polylactic acid, ethylene-vinyl acetate, polystyrene, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramic and combinations of two or more of the foregoing; and drying the liquid coated substrate to provide a color stable antimicrobial article comprising silver salt applied to the substrate.

In another aspect, the invention provides an article, comprising: a silver salt other than silver sulfate, the silver salt applied to a substrate; and the substrate comprising material selected from the group consisting of polyamide, polyester, polyacetate, polyacrylic, polyolefin, polyurethane, polyvinylchloride, polyvinyl alcohol, polycarbonate, polyvinylpyrrolidone, polylactic acid, ethylene-vinyl acetate, polystyrene, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramic and combinations of two or more of the foregoing; and wherein the article is antimicrobial and color stable.

In another aspect of the invention, a method is provided, comprising: applying a silver composition to a substrate to provide a liquid coated substrate, the silver composition comprising a silver salt selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing; and heating the liquid coated substrate at a temperature sufficient to form silver metal from silver salt to provide a color stable antimicrobial article comprising silver metal nanoparticles and silver salt.

In another aspect, the invention provides a method of making an antimicrobial article, comprising: applying a silver composition to a substrate to provide a liquid coated substrate, the silver composition comprising a silver salt other than silver sulfate; and heating the liquid coated substrate at a temperature sufficient to form silver metal from silver salt to provide a color stable antimicrobial article comprising silver metal nanoparticles and silver salt.

In still another aspect, the invention provides an article, comprising: a silver metal and silver salt disposed on a substrate, the silver salt selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing.

In still another aspect, the invention provides an article, comprising: a silver metal and silver salt applied to a substrate, the silver salt comprising a silver salt other than silver sulfate.

The terminology used herein will be understood to have the same meaning as understood by those skilled in the art. Notwithstanding the foregoing statement, certain terms shall be understood to have the meaning set forth herein.

As used herein, “Ambient temperature” means the existing room temperature, typically within a range from about 15° C. to about 30° C.

“Relative humidity” means the ratio of the amount of water vapor actually present in the air to the greatest amount possible at the same temperature.

As used herein, “a,” “an,” “the,” “at least one,” and “one or more” are used interchangeably.

Those skilled in the art will more fully appreciate the scope of the present invention upon consideration of the remainder of the disclosure, including the Detailed Description Of Embodiments Of The Invention, the various Examples and the appended claims.

### DETAILED DESCRIPTION OF EMBODIMENTS OF THE INVENTION

The present invention provides antimicrobial articles that contain silver. The articles are color stable (when exposed to UV or visible light), release antimicrobial levels of silver ions, are surprisingly easy to manufacture and can be made into wound dressings, wound packing materials, or other material suitable for application directly on a wound.

In describing the embodiments of the invention, the term “color stable” means that the article does not exhibit a significant observable change in color and/or homogeneity of color over time (e.g., for at least 4 hours after exposure to light). Color change can be evaluated in any of a variety of ways, and the present invention is not limited to a particular method or technique to determine color change.

In some embodiments of the invention, color change is evaluated by observation.

In some embodiments, color change is evaluated using a graduated scale. For example, color change may be evaluated by observing a sample under fluorescent lighting and assigning a rating from 0 to 10 to the color of the sample by comparing it to color standards. A rating of 0, 1 or 2 is considered to be “white” including white to cream. A rating from 3 through 5 is “yellow” including light yellow to golden yellow, and a rating from 6 through 10 is classified as rust to dark brown. A numerical value for color change is obtained by obtained by subtracting the initial rating from the rating after treatment. Positive ratings for color change represent a darkening in appearance and negative ratings represent a lightening in appearance. A color change on this scale of 1 or less is considered acceptable (e.g., no significant change) as long as the color is initially homogeneous and remains so. If the color is initially non-homogeneous, a color change of 0.5 is considered significant.

In some embodiments, color change can also be measured using a colorimeter such as a Minolta Chroma Meter (CR-300, manufactured by Konica Minolta Photo Imaging U.S.A., Inc., Mahwah, N.J.) using tristimulus values. A color change on this scale in the “Y” value of 15% or less is considered to be acceptable as long as the color of the sample remains homogeneous. If the color is non-homogeneous, a color change of 5% in the “Y” value is considered a significant.

In still other embodiments, color change can be measured using a colorimeter according to test method ASTM D2244. The resulting CIELAB color difference (DE*), between the sample after exposure for the indicated period of time and the unexposed sample can be determined. For purposes of reference only, a DE*, or color change of about 2 units is considered to be the threshold for detection by the naked eye whereas a DE* of 20 or greater represents a substantial or significant color change.

Typically, the art has relied on the use of chemical compounds known as stabilizers to provide color stability to articles that include silver salt. But, such stabilizers can also reduce the solubility of silver salts so that the release of silver ions can be too low (less than 0.01 mg/g dressing in water in 30 minutes) to be efficacious for a wound.

In one embodiment of the present invention, color stability is achieved by applying a silver composition onto a substrate and drying the article. When an appropriate substrate is used to make the articles of the invention, the dried article is color stable without the need to include stabilizers or the like.

In another embodiment of the present invention, color stability is achieved by reducing a portion of silver salt (preferably less than 30%) applied to a substrate to nano-scale silver metal particles (“nanoparticles”) via drying at an elevated temperature to create a product that is color stable with a color that is often observed as light yellow to golden brown as a result of the formation of silver metal nanoparticles.

In one aspect of the invention, a method is provided for making antimicrobial articles by applying (e.g., coating) silver compound(s) onto a substrate to provide a color stable antimicrobial article comprising silver salt.

In another aspect of the invention, a method is provided for making antimicrobial articles by applying (e.g., coating) silver compound(s) onto a substrate to provide a color stable antimicrobial article comprising silver metal and silver salt.

In some embodiments, a silver composition is first prepared by dissolving silver salt in a suitable solvent (e.g., water) to provide a coatable liquid silver composition in the form of a silver salt solution. In some embodiments, the solvent used in the silver composition consists of water. In some embodiments, the solvent in the silver composition is predominantly water along with other ingredients that enhance the solubility of the silver salt. Silver salts suitable for use in the present invention can be selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing.

In certain embodiments, any one of the foregoing salts is suitable by itself or in combination with any other silver salt. Silver sulfate is not included with the foregoing salts.

In some embodiments, the silver salt is selected from a subset of the foregoing salts consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.

In some embodiments, the silver salt is selected from another subset of the salts consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.

In some embodiments, the silver salt is selected to exclude silver sulfate. In some embodiments, the silver salt is silver nitrate. In some embodiments, the salt is silver benzoate.

The silver composition may be formulated with a total silver content of up to about 1.0% by weight, typically between about 0.01% and about 0.5% by weight in the composition. In some embodiments, the pH of the silver composition is maintained at a desired target value in order to avoid adverse effects to the substrate when the composition is applied thereto. In some embodiments, the pH of the silver composition is maintained at 9 or less. In some embodiments, the pH of the silver composition is maintained above 4 but less than 7, to minimize adverse effects to cellulosic substrates, for example.

Color stability is achieved in the finished articles of the invention without the need to include added stabilizing agent(s) to the silver composition; however, it will be appreciated that, in some embodiments of the invention, small amounts of stabilizing agent(s) may be included in the silver composition. Stabilizing agents include ammonia, ammonium salts (e.g., ammonium acetate, ammonium sulfate, ammonium carbonate and the like), thiosulfates, water insoluble salts of metals (e.g., halides such as chlorides), peroxides, magnesium trisilicate, and/or polymers. Stabilizing agents, when present in the silver composition, may be present in amounts less than 100 ppm. In some embodiments, stabilizers may be present in amounts less than 50 ppm, and in some embodiments less than 20 ppm, based on the total weight of the silver salt composition. Alternatively, stabilizing agents are present in amounts less than 1000 ppm based on the total weight of the dried color stable antimicrobial article. In still other embodiments, stabilizing agents are present in amounts less than 500 ppm based on the total weight of the dried color stable antimicrobial article, and in still other embodiments stabilizing agents are present in amounts less than 100 ppm, based on the total weight of the dried color stable antimicrobial article.

In some embodiments, the silver composition may optionally include compounds to facilitate solubility of the silver salt in the solvent (e.g., water). Depending on the solubility of the salt(s) selected for use in the present invention, embodiments of the invention may include solubilizing agents selected from the group consisting of ammonium pentaborate, ammonium acetate, ammonium carbonate, ammonium peroxyborate, ammonium tertraborate, triammonium citrate, ammonium carbamate, ammonium bicarbonate, ammonium malate, ammonium nitrate, ammonium nitrite, ammonium succinate, ammonium sulfate, ammonium tartarate, and combinations of two or more of the foregoing. In the selected of solubilizing agents for inclusion in the silver composition of the invention, preference is given to substances that will evaporate or degrade following application of the composition on a substrate and heating as described herein.

The thus formulated silver composition is applied to a substrate to provide a liquid coated substrate. In some embodiments, the silver composition will penetrate and impregnate the interior of the substrate. For example, when absorbent materials (e.g., gauze), the silver composition impregnates between the fibers of the substrate. Application of the silver composition to a substrate can be accomplished as a continuous process, or it can be done in a discrete manner and even in a single step.

Any of a variety of materials may be used as a substrate or substrate material to which the silver composition is applied.

In certain embodiments, suitable materials can include polymeric materials or is comprised of large, long chain molecules. In certain embodiments, the material for the substrate is typically selected to be ‘non-oxidizable’ in that it does not readily oxidize in the presence of silver salts (e.g., silver nitrate) when heated to temperatures below about 120° C. Suitable substrates include materials selected from the group comprising or consisting of polyamide, polyester, polyacetate, polyacrylic, polyolefins (e.g., polypropylene polyethylene, ethylene propylene copolymers, and ethylene butylene copolymers), polyurethanes (including polyurethane foams), polyvinylchloride, polyvinyl alcohol, polycarbonate, polyvinylpyrrolidone, polylactic acid, ethylene-vinyl acetate, polystyrenes, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramics and combinations of two or more of the foregoing.

In some embodiments of the invention, the substrate comprises or consists of cellulose acetate. In some embodiments, the substrate comprises or consists of polyamide (e.g., Nylon 6, 6).

In certain embodiments, suitable materials can include cellulosic and non-cellulosic materials such as, for example, paper, natural or synthetic fibers, threads and yarns made from materials such as cotton, rayon, hemp, jute, bamboo fibers, cellulose acetate, carboxymethylated solvent-spun cellulose fibers, polyamides, polyacetates, alginates, collagen, gelatin, natural rubber, polyacrylamide, and combinations of two or more of the foregoing.

In addition, the above material or combinations thereof can be combined with other materials such as polyesters, polyacrylics, polyolefins (e.g., polypropylene polyethylene, ethylene propylene copolymers, and ethylene butylene copolymers), polyurethanes (including polyurethane foams), vinyls including polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer, and combinations of two or more of the foregoing. Combinations of materials may be included within a substrate. In some embodiments, the substrate comprises a material selected from the group consisting of cellulosic material, nylon, polyester fiber, and combinations of two or more of the foregoing.

The substrate can be porous or nonporous, and the silver composition can be coated onto a surface of the substrate or impregnated into it, for example. In embodiments of the invention, the substrate may be flexible and can comprise woven or nonwoven materials made of natural or synthetic compounds. In embodiments of the invention, the substrate may be selected from polymeric webs (non-woven or woven), polymer films, hydrocolloids, foams, paper, and/or combinations of the foregoing.

In some embodiments, the substrate can be an absorbent cotton gauze.

Porous substrates made from the foregoing materials can include knits, wovens (e.g., cheese cloth and gauze), nonwovens (including spun-bonded nonwovens, and BMF (blown micro fibers), extruded porous sheets, and perforated sheets. The apertures (i.e., openings) in the porous substrates are of sufficient size and sufficient number to facilitate high breathability. For certain embodiments, the porous substrates have at least 1 aperture per square centimeter. For certain embodiments, the porous substrates have no greater than 225 apertures per square centimeter. For certain embodiments, the apertures have an average opening size (i.e., the largest dimension of the opening) of at least 0.1 millimeter (mm). For certain embodiments, the apertures have an average opening size (i.e., the largest dimension of the opening) of no greater than 0.5 centimeter (cm). In some embodiments, the porous substrates have a basis weight of at least 5 grams/meter². In some embodiments, the porous substrates have a basis weight of no greater than 1000 grams/meter², and in some embodiments no greater than 200 grams/meter². Porous substrates may be flexible yet resistant to tearing. For some embodiments, the thickness of the porous substrates is at least about 0.0125 millimeter (mm). For certain embodiments, the thickness of the porous substrates is no greater than about 15 mm, and for certain embodiments no greater than about 3 mm.

In some embodiments, the substrate comprises permeable material(s) that allow for moisture vapor transmission therethrough. For some embodiments, the substrate may be a hydrocolloid, such as a hydrophilic polymer, or hydrophobic polymer matrix containing hydrophilic particles, as described in U.S. Pat. App. Pub. Nos. 2004/0180093 and 2005/0124724.

Cellulosic materials may be suitable for use in certain embodiments of the invention, including polysaccharide or modified polysaccharide, regenerated cellulose (such as rayon), paper, cotton, carboxymethyl cellulose, and the like. In embodiments of the invention where the finished article is intended for use as a wound dressing or will be used in a moist or wet environment, it may be advantageous to provide a substrate comprising absorbent materials. Suitable absorbent materials include those made from or incorporating cellulose fibers such as carboxymethylated materials—carboxymethylated cotton, carboxymethylated cellulose, carboxymethylated rayon. Suitable commercial cellulosic fibers include solvent-spun cellulosic fibers known under the trade designation “TENCEL” available from Lenzing Fibers, Inc. Carboxymethylated variations of the foregoing TENCEL fibers, as disclosed in WO1993012275 A1, are also suitable for use in certain embodiments of the invention.

In some embodiments, the substrates are substantially impervious to liquid, especially wound exudate.

The silver composition can be applied at ambient temperatures, typically at temperatures less than about 70° C. The silver composition can be coated onto a substrate using any of a variety of known coating techniques such as gravure coating, curtain coating, die coating, knife coating, roll coating, spray coating and the like. In some embodiments, the substrate can be dipped into or passed through a bath of the silver composition.

Following the application of silver salt, moderate heat may be applied to the liquid coated substrate at a temperature and for a duration sufficient to dry the article to provide a color stable antimicrobial article. Sufficiently elevated temperatures may be attained in an oven and, in certain embodiments of the invention, the temperature is less than 100° C. and typically within the range from about 50° C. to about 90° C. Alternatively, the liquid coated substrate may be air dried at ambient or room temperature. Actual drying temperatures may vary depending on the amount of time allotted for drying, the silver loading on the liquid coated substrate, the type and weight of the substrate and the like. Those skilled in the art will appreciate that the temperature should be high enough to dry the article without reducing the silver salt or oxidizing the substrate. In this manner, the dried article is color stable. Not wishing to be bound by theory, it is believed that the articles of the invention produced in this manner are color stable due in part to the non-oxidizable substrate(s) being used. For some embodiments of this invention, the drying temperature can by higher than 100° C. as long as the substrate is not oxidized by silver nitrate to form silver metal or the substrate does not melt or burn. Polyester is an example of this type of substrate.

In certain embodiments, heat is applied to the liquid coated substrate at a temperature and for a duration sufficient to dry the article (by removing the solvent from the silver composition) and to reduce at least a portion of the silver salt to silver metal to provide a color stable antimicrobial article. At least a portion of the silver metal is in the form of nanoparticles of silver. As used herein, “nanoparticle” refers to a microscopic particle whose size is measured in nanometers (nm) having at least one dimension less than about 200 nm. To accomplish the formation of silver metal, the drying temperature for the liquid coated substrate is elevated above room temperature. Sufficiently elevated temperatures are attained in an oven and, in certain embodiments of the invention, the temperature is in excess of about 95° C. and within the range from about 95° C. to about 225° C. In some embodiments, the liquid coated substrate is dried at temperatures between about 100° C. and about 200° C. In still other embodiments, the liquid coated substrate is dried at temperatures between about 110° C. and about 180° C. In still other embodiments, the liquid coated substrate is dried at temperatures between about 130° C. and about 175° C. Actual drying temperatures may vary depending on the amount of time allotted for drying, the silver loading on the liquid coated substrate, the type and weight of the substrate and the like. Those skilled in the art will appreciate that the temperature should be high enough to achieve the reduction of silver (I), in embodiments where desired. But, consideration must also be given to the melting temperature and oxidation potential of the substrate. Those skilled in the art will appreciate that substrate materials suitable for use as wound dressings, for example, may comprise materials that are readily oxidizable at higher temperatures (e.g., cellulosic materials) so that prolonged heating or exposure to very high temperatures may be detrimental to the quality and/or the integrity of the finished article. An excessively high drying temperature can burn or melt some substrate materials and render them unfit for their intended purpose (e.g., as a wound dressing).

In certain embodiments, the finished article includes silver metal and silver salt affixed to a substrate. Not wishing to be bound by any theory, it is believed that the heating of the liquid coated substrate in certain embodiments oxidizes the substrate and reduces the silver salt to silver metal. Oxidation of the substrate and formation of nanoparticles of metallic silver are believed to be responsible for the color(s) and the color stability observed in certain of the finished antimicrobial articles of the invention. On white substrates (e.g., cellulosic materials), heat treating the liquid coated substrate can result in a finished article having a non-white color (e.g., yellow to brown) that is stable for extended periods of time after exposure to light and/or heat.

Preferably, the articles of the invention remain stable to light (e.g., visible, UV) such that they are color stable. Preferably, they release antimicrobially efficacious levels of silver ions and, in certain embodiments of the invention, are readily applicable to skin wounds as a wound dressing. The articles are simple to manufacture, and are generally free of added stabilizers.

In certain embodiments, the present invention provides a wound dressing that comprises readily soluble silver salt(s) applied to a substrate. In other embodiments, the present invention provides a wound dressing that comprises nanoparticles of silver metal as well as readily soluble silver salt(s) applied to and disposed on a substrate. As used herein, “applied to” and “disposed on” refer to the placement of the silver onto a substrate so that the silver and/or silver salt is on a substrate surface and, in the case of absorbent materials, may also be distributed within the interior of a substrate (e.g., throughout the absorbent structure between the outermost surfaces).

In embodiments wherein the finished article is to be used as a wound dressing, an antimicrobially effective amount of silver is available for delivery from the article to the wound bed, or the like. The article typically maintains efficacious levels of silver release (e.g., greater than 0.01 mg/g dressing in 100 g water in 30 minutes). The color of the finished article is stable (e.g., to heat and light). In certain embodiments of the invention, the article is color stable for more than 4 hours, in some embodiments, for more than 8 hours, and, in some embodiments, longer than 24 hours following exposure of the article to visible or UV light. The light stability of the articles of the invention can be prolonged by packaging the article in light-proof packaging or storing the article in a light-free environment until the article is to be used.

The concentration of silver (in certain embodiments as silver salt, and in certain embodiments as a silver salt plus silver metal) on the dried substrate is preferably less than about 40,000 milligrams (mg) Ag per kilogram (kg) substrate, and in some embodiments less than about 20,000 mg Ag/kg substrate. In still other embodiments, the concentration of silver is less than about 10,000 mg Ag/kg substrate.

In embodiments of the invention in which the silver is present as a silver salt and silver metal, of the total amount of silver on the substrate, less than 30% is typically present as silver metal.

In some embodiments, the articles of the invention are medical articles such as wound dressings and wound packing materials or other material that is applied directly to or contacts a wound. However, the articles of the invention may be used in other applications (medical and non-medical applications) where the antimicrobial properties of silver are needed or desired. Other potential products include clothing, bedding, masks, dust cloths, shoe inserts, diapers, and hospital materials such as blankets, surgical drapes, and gowns.

The stability of the articles of the invention may be prolonged and/or increased when the relative humidity at room temperature is maintained at 50% or lower; more preferably at 30% or lower; and most preferably at 20% or lower. Relative humidity can be reduced to 30%, and preferably to 20%, or lower for the article of the invention by a number of methods including, for example: 1) placing the article in an environment that has a relative humidity of 30% or lower, preferably 20% or lower, and then packaging the article in the same environment; 2) drying the liquid coated substrate in an oven and immediately packaging the resulting article; and/or 3) adding a desiccant within the article's packaging. Environments suitable to maintain a low humidity include packaging made of material having a low moisture vapor transmission rate (MVTR) such as a Techni-Pouch package (e.g., commercially available from Technipaq, Inc., Crystal Lake, Ill.) with a PET/Aluminum Foil/LLDPE material construction.

In certain embodiments, the articles of the invention are nonadherent, although it will be understood that an adhesive (e.g., a pressure sensitive adhesive) can be applied to an article in a known manner. Pressure sensitive adhesive suitable for use in medical articles can be used in the articles of the present invention. That is, a pressure sensitive adhesive can be applied to a surface of the article of this invention to facilitate adherence of the article to the skin. The adhesive may be applied, for example, around the periphery of a surface of the article so that the silver-containing surface of the article is adhesively held to the skin in contact with a wound, or the like. In this manner, under the moist conditions of a wound bed, the article will release silver ions into the wound to prevent microbial growth.

In certain embodiments, substrates coated with the silver composition can be covered on one or both sides by a permeable nonadherent outside layer to reduce adhesion and attachment to the wound. The nonadherent layer can be attached to the substrate by coating or laminating, for example. Alternatively, the coated substrate can be enclosed within a nonadherent layer, such as a sleeve. The nonadherent layer can be made from nonadherent woven or nonwoven fabrics such as nylon or perfluorinated-material coatings on cotton gauze. The nonadherent layer prevents attachment of the wound dressing to the wound. At the same time, the nonadherent layer does not adversely affect the sustained release of silver from the coated substrate.

In another embodiment, the substrate or support substrate can be composed of nonadherent material. For example, a nonadherent hydrophilic polymer can be used as the substrate or support material, or coated on a permeable porous substrate, as described in U.S. Pat. Pub. Nos. 2004/0180093, 2005/0123590, and 2005/0124724.

If desired, the coated substrate can be covered with two protective films (for example, thin polyester films). These films optionally may include a nonstick treatment and can function to facilitate extraction from a package and in handling the article. If desired, the coated substrate can be cut into individual compresses, of sizes suitable for the use, packaged in sealed sachets, and sterilized.

### Illustrative Embodiments

1. A method of making an antimicrobial article, comprising:

applying a silver composition to a substrate to provide a liquid coated substrate, the silver composition comprising a silver salt other than silver sulfate in a solvent, the silver composition comprising a stabilizing agent in an amount less than about 100 ppm;

the substrate comprising material selected from the group consisting of polyamide, polyester, polyacetate, polyacrylic, polyolefin, polyurethane, polyvinylchloride, polyvinyl alcohol, polycarbonate, polyvinylpyrrolidone, polylactic acid, ethylene-vinyl acetate, polystyrene, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramic and combinations of two or more of the foregoing; and

drying the liquid coated substrate to provide a color stable antimicrobial article comprising silver salt applied to the substrate.

2. The method of embodiment 1, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.
3. The method of embodiment 2, wherein the silver salt is silver nitrate.
4. The method of embodiment 2, wherein the silver salt is silver benzoate.
5. The method of embodiment 1, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.
6. The method of any one of embodiments 1 through 5, wherein the substrate comprises polyolefin selected from the group consisting of polypropylene, polyethylene, ethylene propylene copolymers, ethylene butylene copolymers, and combinations of two or more of the foregoing.
7. The method of any one of embodiments 1 through 5, wherein the substrate comprises polyamide.
8. The method of any one of embodiments 1 through 5, wherein the substrate comprises cellulose acetate.
9. The method of any one of embodiments 1 through 8, wherein the substrate comprises material selected from the group consisting of knits, wovens, nonwovens, extruded porous sheets, and perforated sheets.
10. The method of any one of embodiments 1 through 9, wherein the silver composition comprises a stabilizing agent in an amount less than 50 ppm based on the total weight of the silver salt composition.
11. The method of embodiment 10, wherein the silver composition comprises no stabilizing agent.
12. The method of any one of embodiments 1 through 11, wherein drying the liquid coated substrate is accomplished at room temperature.
13. The method of any one of embodiments 1 through 11, wherein drying the liquid coated substrate is accomplished a temperature less than about 100° C.
14. The method of any one of embodiments 1 through 13 wherein the color stable antimicrobial article comprises silver salt applied to the substrate with a concentration of silver on the substrate being less than about 40,000 mg Ag/kg substrate.
15. The method of embodiment 14 wherein the color stable antimicrobial article comprises silver salt applied to the substrate with a concentration of silver on the substrate being less than about 20,000 mg Ag/kg substrate.
16. The method of embodiment 15 wherein the color stable antimicrobial article comprises silver salt applied to the substrate with a concentration of silver on the substrate being less than about 10,000 mg Ag/kg substrate.
17. An article, comprising:

a silver salt other than silver sulfate, the silver salt applied to a substrate; and

the substrate comprising material selected from the group consisting of polyamide, polyester, polyacetate, polyacrylic, polyolefin, polyurethane, polyvinylchloride, polyvinyl alcohol, polycarbonate, polyvinylpyrrolidone, polylactic acid, ethylene-vinyl acetate, polystyrene, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramic and combinations of two or more of the foregoing; and

wherein the article is antimicrobial and color stable.

18. The article of embodiment 17 wherein the silver salt is selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing.
19. The article of embodiment 18, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.
20. The article of embodiment 19, wherein the silver salt is silver nitrate.
21. The article of embodiment 19, wherein the silver salt is silver benzoate.
22. The article of embodiment 18, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.
23. The article of any one of embodiments 17 through 22, wherein the substrate comprises polyamide.
24. The article of any one of embodiments 17 through 22, wherein the substrate comprises cellulose acetate.
25. The article of any one of embodiments 17 through 24, wherein the concentration of silver on the substrate is less than about 40,000 mg Ag/kg substrate.
26. The article of embodiment 25, wherein the concentration of silver on the substrate is less than about 20,000 mg Ag/kg substrate.
27. The article of embodiment 26, wherein the concentration of silver on the substrate is less than about 10,000 mg Ag/kg substrate.
28. The article of any one of embodiments 17 through 27, wherein the concentration of a stabilizing agent is less than about 1000 ppm based on the total weight of the article.
29. The article of embodiment 28, wherein the concentration of a stabilizing agent is less than about 500 ppm based on the total weight of the article.
30. The article of embodiment 29, wherein the concentration of a stabilizing agent is less than about 100 ppm, based on the total weight of the article.
31. A method of making an antimicrobial article, comprising:

applying a silver composition to a substrate to provide a liquid coated substrate, the silver composition comprising a silver salt selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing; and

heating the liquid coated substrate at a temperature sufficient to form silver metal from silver salt to provide a color stable antimicrobial article comprising silver metal nanoparticles and silver salt.

32. The method of embodiment 31, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.
33. The method of embodiment 32, wherein the silver salt is silver nitrate.
34. The method of embodiment 32, wherein the silver salt is silver benzoate.
35. The method of embodiment 31, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.
36. The method of any one of embodiments 31 through 35, wherein the substrate comprises a material selected from the group consisting of cellulosic material, nylon, polyamides, polyacetates, collagen, gelatin, polyacrylamide, natural rubber, alginates, and combinations of two or more of the foregoing.
37. The method of embodiment 36, wherein the substrate also comprises material selected from the group consisting of polyesters, polyacrylics, polyolefins, polyurethanes, vinyls including polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer and combinations of two or more of the foregoing.
38. The method of embodiment 36 or 37, wherein the substrate comprises cellulosic material.
39. The method of embodiment 38, wherein the cellulosic material is absorbent carboxymethylated material selected from the group consisting of carboxymethylated cotton, carboxymethylated cellulose, carboxymethylated solvent-spun cellulose fibers, and carboxymethylated rayon and combinations of two or more of the foregoing.
40. The method of embodiment 38, wherein the cellulosic material is selected from the group consisting of cotton, rayon, hemp, jute, bamboo fibers, cellulose acetate, carboxymethylated solvent-spun cellulose fibers and combinations of two or more of the foregoing.
41. The method of any one of embodiments 31 through 40, wherein the substrate comprises material selected from the group consisting of knits, wovens, nonwovens, extruded porous sheets, and perforated sheets.
42. The method of any one of embodiments 31 through 41, wherein heating the liquid coated substrate is accomplished at a temperature within the range from about 95° C. to about 225° C.
43. The method of embodiment 42, wherein heating the liquid coated substrate is accomplished at a temperature within the range from about 100° C. to about 200° C.
44. The method of embodiment 43, wherein heating the liquid coated substrate is accomplished at a temperature within the range from about 110° C. to about 180° C.
45. The method of embodiment 44, wherein heating the liquid coated substrate is accomplished at a temperature within the range from about 130° C. to about 175° C.
46. The method of any one of embodiments 31 through 45, wherein the silver salt solution comprises a stabilizing agent in an amount less than 100 ppm based on the total weight of the silver composition.
47. The method of embodiment 46, wherein the silver salt solution comprises no stabilizing agent.
48. The method of any one of embodiments 31 through 47, wherein the antimicrobial article is color stable having a non-white color.
49. A method of making an antimicrobial article, comprising:

applying a silver composition to a substrate to provide a liquid coated substrate, the silver composition comprising a silver salt other than silver sulfate; and

heating the liquid coated substrate at a temperature sufficient to form silver metal from silver salt to provide a color stable antimicrobial article comprising silver metal nanoparticles and silver salt.

50. The method of embodiment 49, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.
51. The method of embodiment 50, wherein the silver salt is silver nitrate.
52. The method of embodiment 50, wherein the silver salt is silver benzoate.
53. The method of embodiment 49, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.
54. The method of any one of embodiments 49 through 53, wherein the substrate comprises material selected from the group consisting of cellulosic material, nylon, polyamides, polyacetates, collagen, gelatin, polyacrylamide, natural rubber, alginates and combinations of two or more of the foregoing.
55. The method of embodiment 54, wherein the substrate also comprises material selected from the group consisting of polyesters, polyacrylics, polyolefins, polyurethanes, polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer, and combinations of two or more of the foregoing.
56. The method of embodiment 54 or 55, wherein the substrate comprises cellulosic material.
57. The method of embodiment 56, wherein the cellulosic material comprises absorbent carboxymethylated materials selected from the group consisting of carboxymethylated cotton, carboxymethylated cellulose, carboxymethylated solvent-spun cellulose fibers, and carboxymethylated rayon and combinations of two or more of the foregoing.
58. The method of embodiment 56, wherein the cellulosic material is selected from the group consisting of cotton, rayon, hemp, jute, bamboo fibers, cellulose acetate, carboxymethylated solvent-spun cellulose fibers and combinations of two or more of the foregoing.
59. The method of any one of embodiments 49 through 58, wherein the substrate comprises material selected from the group consisting of knits, wovens, nonwovens, extruded porous sheets, and perforated sheets.
60. The method of any one of embodiments 49 through 59, wherein heating the liquid coated substrate is accomplished at a temperature within the range from about 95° C. to about 225° C.
61. The method of embodiment 60, wherein heating the liquid coated substrate is accomplished at a temperature within the range from about 100° C. to about 200° C.
62. The method of embodiment 61, wherein heating the liquid coated substrate is accomplished at a temperature within the range from about 110° C. to about 180° C.
63. The method of embodiment 62, wherein heating the liquid coated substrate is accomplished at a temperature within the range from about 130° C. to about 175° C.
64. The method of any one of embodiments 49 through 63, wherein the silver salt solution comprises a stabilizing agent in an amount less than 100 ppm based on the total weight of the silver composition.
65. The method of embodiment 64, wherein the silver salt solution comprises no stabilizing agent.
66. The method of any one of embodiments 49 through 65, wherein the antimicrobial article is color stable having a non-white color.
67. An article, comprising:

silver metal and silver salt disposed on a substrate, the silver salt selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing.

68. The article of embodiment 67, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.
69. The article of embodiment 68, wherein the silver salt is silver nitrate.
70. The article of embodiment 68, wherein the silver salt is silver benzoate.
71. The article of embodiment 67, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.
72. The article of any one of embodiments 67 through 71, wherein the substrate comprises a material selected from the group consisting of cellulosic material, nylon, polyamides, polyacetates, collagen, gelatin, polyacrylamide, natural rubber, alginates and combinations of two or more of the foregoing.
73. The article of embodiment 72, wherein the substrate also comprises material selected from the group consisting of polyesters, polyacrylics, polyolefins, polyurethanes, polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer and combinations of two or more of the foregoing.
74. The article of embodiment 72 or embodiment 73, wherein the substrate comprises cellulosic material.
75. The article of embodiment 74, wherein the cellulosic material comprise absorbent carboxymethylated materials selected from the group consisting of carboxymethylated cotton, carboxymethylated cellulose, carboxymethylated solvent-spun cellulose fibers, and carboxymethylated rayon and combinations of two or more of the foregoing.
76. The article of embodiment 74, wherein the cellulosic material is selected from the group consisting of cotton, rayon, hemp, jute, bamboo fibers, cellulose acetate, carboxymethylated solvent-spun cellulose fibers and combinations of two or more of the foregoing.
77. The article of any one of embodiments 67 through 76, wherein the substrate is a material selected from the group consisting of knits, wovens, nonwovens, extruded porous sheets, and perforated sheets.
78. The article of any one of embodiments 67 through 77 wherein the antimicrobial article is color stable having a non-white color.
79. The article of any one of embodiments 67 through 78, wherein the concentration of silver on the substrate is less than about 40,000 mg Ag/kg substrate.
80. The article of embodiment 79, wherein the concentration of silver on the substrate is less than about 20,000 mg Ag/kg substrate.
81. The article of embodiment 80, wherein the concentration of silver on the substrate is less than about 10,000 mg Ag/kg substrate.
82. An article, comprising:

a silver metal and silver salt applied to a substrate, the silver salt comprising a silver salt other than silver sulfate.

83. The article of embodiment 82, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.
84. The article of embodiment 83, wherein the silver salt is silver nitrate.
85. The article of embodiment 83, wherein the silver salt is silver benzoate.
86. The article of embodiment 82, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.
87. The article of any one of embodiments 82 through 86, wherein the substrate comprises a material selected from the group consisting of cellulosic material, nylon, polyamides, polyacetates, collagen, gelatin, polyacrylamide, natural rubber, alginates and combinations of two or more of the foregoing.
88. The article of embodiment 87, wherein the substrate also comprises material selected from the group consisting of polyesters, polyacrylics, polyolefins, polyurethanes, polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer and combinations of two or more of the foregoing.
89. The article of embodiment 87 or embodiment 88, wherein the substrate comprises cellulosic material.
90. The article of embodiment 89, wherein the cellulosic material comprise absorbent carboxymethylated materials selected from the group consisting of carboxymethylated cotton, carboxymethylated cellulose, carboxymethylated solvent-spun cellulose fibers, and carboxymethylated rayon and combinations of two or more of the foregoing.
91. The article of embodiment 89, wherein the cellulosic material is selected from the group consisting of cotton, rayon, hemp, jute, bamboo fibers, cellulose acetate, carboxymethylated solvent-spun cellulose fibers and combinations of two or more of the foregoing.
92. The article of any one of embodiments 82 through 91, wherein the substrate is a material selected from the group consisting of knits, wovens, extruded porous sheets, and perforated sheets.
93. The article of any one of embodiments 82 through 92, wherein the antimicrobial article is color stable having a non-white color.
94. The article of any one of embodiments 82 through 93, wherein the concentration of silver on the substrate is less than about 40,000 mg Ag/kg substrate.
95. The article of embodiment 94, wherein the concentration of silver on the substrate is less than about 20,000 mg Ag/kg substrate.
96. The article of embodiment 95, wherein the concentration of silver on the substrate is less than about 10,000 mg Ag/kg substrate.

### EXAMPLES

Objects and advantages of this invention are further illustrated by the following examples, but the particular materials and amounts thereof recited in these examples, as well as other conditions and details, should not be construed to unduly limit this invention. Unless otherwise indicated, all parts and percentages are on a weight basis, all water is distilled water, and all molecular weights are weight average molecular weight.

### I.

### Example I-1

A silver nitrate coating solution was prepared by placing 0.316 grams (g) silver nitrate (Aldrich Chemical Co., Milwaukee, Wis.) and 200 g distilled water in a glass bottle and capping the bottle and mixing at room temperature in a shaker overnight. Approximately 6 grams of this silver nitrate solution (approximately 1000 micrograms (μg) Ag per gram (g)) solution was coated on an approximately 4-inch×4-inch piece of 100% nylon woven from American Fiber and Finishing in Albemarle, N.C. (SR-823-32x28, 60 gsm) by transferring the solution by pipette to saturate the mesh that was contained in a polystyrene dish. Approximately one gram of coating solution dripped off of the mesh before the mesh was suspended in the oven for drying. Some additional solution dripped off the mesh in the oven (estimated at 1 g). The coated mesh was dried in a forced air oven (Memmert Universal Oven, available from Wisconsin Oven Company, East Troy Wisconsin) by heating at 80° C. for 12 minutes. The resulting material after drying was white in appearance. These coated samples were either wrapped in aluminum foil (protected from light), exposed to fluorescent light (Philips, F32T8/TL735, Universal/Hi-Vision, E4) in an environment of approximately 20-30% relative humidity environment, or exposed to fluorescent light (Philips, F32T8/TL735, Universal/Hi-Vision, K4) in an environment of 45-50% relative humidity. Color ratings of these samples were measured over time using a Minolta Chroma Meter (CR-300, manufactured by Konica Minolta Photo Imaging U.S.A., Inc., Mahwah, N.J.). The results are shown in Table I-1.

TABLE I-1
Example I-1 Color with Time

| | Relative | | | | |
|---|---|---|---|---|---|
| Exposure | Humidity | Exposure | CIE Tristimulus Values | | |
| Time (hr) | (% RH) | conditions | X | Y | Z |
| 0 | 28% | In foil | 90.46 | 92.38 | 104.24 |
| 2 | 28% | In foil | 90.35 | 92.27 | 103.81 |
| 4 | 28% | In foil | 90.25 | 92.18 | 104.13 |
| 8 | 28% | In foil | 90.74 | 92.66 | 104.54 |
| 24 | 28% | In foil | 89.14 | 91.07 | 102.49 |
| 0 | 28% | exposed | 89.86 | 91.83 | 102.38 |
| 2 | 28% | exposed | 87.31 | 89.10 | 99.42 |
| 4 | 28% | exposed | 87.33 | 89.04 | 98.99 |
| 8 | 28% | exposed | 85.79 | 87.36 | 95.76 |
| 24 | 28% | exposed | 80.39 | 81.67 | 87.63 |
| 0 | 50% | exposed | 89.75 | 91.67 | 102.80 |
| 2 | 50% | exposed | 85.72 | 87.38 | 97.79 |
| 4 | 50% | exposed | 84.75 | 86.29 | 96.40 |
| 8 | 50% | exposed | 82.21 | 83.64 | 92.39 |
| 24 | 50% | exposed | 74.65 | 75.76 | 79.76 |

### Example I-2

Samples were prepared in same way as Example I-1, except the silver solution was silver benzoate (Alfa Aesar; Ward Hill, Mass.) and this solution was prepared by placing 0.459 g silver benzoate and 200 g distilled water in a glass bottle. This resulting silver benzoate solution was approximately 1000 μg Ag/g. The color of the samples was white. The results from color monitoring experiments are shown in Table I-2.

TABLE I-2
Example I-2 Color with Time

| | Relative | | | | |
|---|---|---|---|---|---|
| Exposure | Humidity | Exposure | CIE Tristimulus Values | | |
| Time (hr) | (% RH) | conditions | X | Y | Z |
| 0 | 28% | In foil | 90.39 | 92.35 | 103.28 |
| 2 | 28% | In foil | 89.81 | 91.79 | 102.56 |
| 4 | 28% | In foil | 89.51 | 91.40 | 103.01 |
| 8 | 28% | In foil | 90.78 | 92.73 | 102.80 |
| 24 | 28% | In foil | 87.44 | 89.39 | 98.96 |
| 0 | 28% | exposed | 89.71 | 91.72 | 101.82 |
| 2 | 28% | exposed | 86.34 | 88.18 | 97.11 |
| 4 | 28% | exposed | 82.12 | 83.79 | 91.43 |
| 8 | 28% | exposed | 82.40 | 83.91 | 88.86 |
| 24 | 28% | exposed | 75.94 | 77.12 | 78.34 |
| 0 | 50% | exposed | 89.27 | 91.23 | 100.30 |
| 2 | 50% | exposed | 83.27 | 84.98 | 92.34 |
| 4 | 50% | exposed | 81.03 | 82.47 | 87.90 |
| 8 | 50% | exposed | 79.02 | 80.33 | 82.68 |
| 24 | 50% | exposed | 67.65 | 68.40 | 65.26 |

### Example I-3

### Comparative

The color ratings over time at of a commercially available wound dressing were also measured during exposure to light. This commercially available wound dressing of the tradename AQUALCEL Ag, Lot 5F05519 from ConvaTec, contains silver chloride/silver alginate with high levels of chloride which acts as a stabilizer and has an initial off-white color. During exposure to light, the color of the sample became noticeably gray. The results from these experiments are shown in Table I-3.

TABLE I-3
Example I-3 (Comparative) Color with Time

| | Relative | | CIE Tristimulus | | |
|---|---|---|---|---|---|
| Exposure | Humidity | Exposure | Values | | |
| Time (hr) | (% RH) | conditions | X | Y | Z |
| 0 | 12% | In foil | 53.51 | 53.75 | 64.21 |
| 2 | 12% | In foil | 53.03 | 53.30 | 63.85 |
| 4 | 11% | In foil | 52.90 | 53.22 | 63.91 |
| 8 | 12% | In foil | 53.40 | 53.73 | 64.41 |
| 24 | 11% | In foil | 53.53 | 53.66 | 64.44 |
| 48 | 10% | exposed | 53.41 | 53.74 | 64.57 |
| 120 | 16% | exposed | 52.31 | 52.61 | 63.28 |
| 168 | 18% | exposed | 52.67 | 53.01 | 63.60 |
| 0 | 12% | exposed | 51.75 | 52.09 | 62.71 |
| 2 | 12% | exposed | 47.28 | 47.81 | 57.76 |
| 4 | 11% | exposed | 46.20 | 46.58 | 55.52 |
| 8 | 12% | exposed | 44.79 | 45.29 | 53.37 |
| 24 | 11% | exposed | 43.30 | 43.60 | 50.25 |
| 48 | 10% | exposed | 41.44 | 41.67 | 47.11 |
| 120 | 16% | exposed | 39.12 | 39.41 | 44.70 |
| 168 | 18% | exposed | 38.12 | 38.46 | 43.78 |
| 0 | 49% | exposed | 53.06 | 53.37 | 63.67 |
| 2 | 49% | exposed | 47.16 | 47.76 | 58.26 |
| 4 | 49% | exposed | 45.63 | 46.09 | 55.69 |
| 8 | 49% | exposed | 44.07 | 44.48 | 53.31 |
| 24 | 49% | exposed | 40.91 | 41.25 | 48.51 |
| 48 | 49% | exposed | 38.62 | 38.85 | 44.85 |
| 120 | 49% | exposed | 36.54 | 36.49 | 41.75 |
| 168 | 49% | exposed | 34.53 | 34.42 | 39.59 |

### Example I-4

Samples were prepared in same way as Example I-1, except the substrate was a membrane filter comprised of cellulose nitrate and cellulose acetate (0.22 μM filters, GSWP 047 00) from Millipore in Billerica, Mass. The initial color of the samples was white. The results from color monitoring experiments are shown in Table I-4.

TABLE I-4
Example I-4 Color with Time

| | Relative | | | | |
|---|---|---|---|---|---|
| Exposure | Humidity | Exposure | CIE Tristimulus Values | | |
| Time (hr) | (% RH) | conditions | X | Y | Z |
| 0 | 28% | In foil | 95.85 | 97.63 | 113.02 |
| 2 | 28% | In foil | 95.87 | 97.65 | 113.33 |
| 4 | 28% | In foil | 95.72 | 97.49 | 112.31 |
| 8 | 28% | In foil | 96.16 | 97.92 | 113.55 |
| 24 | 28% | In foil | 95.41 | 97.16 | 112.52 |
| 0 | 28% | exposed | 95.39 | 97.16 | 110.68 |
| 2 | 28% | exposed | 93.85 | 95.30 | 108.41 |
| 4 | 28% | exposed | 93.08 | 94.36 | 107.35 |
| 8 | 28% | exposed | 90.68 | 91.51 | 102.44 |
| 24 | 28% | exposed | 82.39 | 82.56 | 88.25 |
| 0 | 50% | exposed | 96.78 | 98.66 | 114.99 |
| 2 | 50% | exposed | 95.51 | 97.18 | 113.02 |
| 4 | 50% | exposed | 93.73 | 95.04 | 109.09 |
| 8 | 50% | exposed | 88.85 | 89.71 | 97.77 |
| 24 | 50% | exposed | 75.61 | 76.06 | 73.34 |

### Example I-5

Samples were prepared in same way as Example I-2, except the substrate was a membrane filter comprised of cellulose nitrate and cellulose acetate (0.22 μM filters, GSWP 047 00) from Millipore in Billerica, Mass. The initial color of the samples was white. The results from color monitoring experiments are shown in Table I-5.

TABLE I-5
Example I-5 Color with Time

| | Relative | | | | |
|---|---|---|---|---|---|
| Exposure | Humidity | Exposure | CIE Tristimulus Values | | |
| Time (hr) | (% RH) | conditions | X | Y | Z |
| 0 | 28% | In foil | 93.47 | 95.19 | 106.56 |
| 2 | 28% | In foil | 93.23 | 94.91 | 106.02 |
| 4 | 28% | In foil | 93.33 | 95.04 | 106.05 |
| 8 | 28% | In foil | 93.59 | 95.31 | 106.54 |
| 24 | 28% | In foil | 93.98 | 95.83 | 108.01 |
| 0 | 28% | exposed | 94.54 | 96.26 | 109.36 |
| 2 | 28% | exposed | 94.84 | 96.63 | 109.90 |
| 4 | 28% | exposed | 94.71 | 96.41 | 109.77 |
| 8 | 28% | exposed | 94.25 | 96.01 | 108.22 |
| 24 | 28% | exposed | 92.18 | 94.04 | 104.00 |
| 0 | 50% | exposed | 95.32 | 97.09 | 111.53 |
| 2 | 50% | exposed | 94.48 | 96.22 | 109.14 |
| 4 | 50% | exposed | 94.41 | 96.08 | 108.78 |
| 8 | 50% | exposed | 92.65 | 94.40 | 103.59 |
| 24 | 50% | exposed | 89.57 | 91.64 | 96.76 |

### Example I-6

Samples were prepared in same way as Example I-1, except the substrate was a 100% polyester spunlaced non-woven (SONTARA 8010, 45 gsm) from E.I. du Pont de Nemours and Company in Wilmington, Del. This polyester non-woven was wetted by mechanically inducing the silver nitrate solution into the pores of the polyester substrate by fingertips of glove covered hands. (Gloves were SAFESKIN powder free purple nitrile exam gloves (Ref 55083 Large) by Kimberly Clark, Roswell, Ga.). The initial color of the samples was white. The results from color monitoring experiments are shown in Table 1-6.

TABLE I-6
Example I-6 Color with Time

| | Relative | | | | |
|---|---|---|---|---|---|
| Exposure | Humidity | Exposure | CIE Tristimulus Values | | |
| Time (hr) | (% RH) | conditions | X | Y | Z |
| 0 | 28% | exposed | 90.47 | 92.32 | 104.25 |
| 2 | 28% | exposed | 89.24 | 90.87 | 102.19 |
| 4 | 28% | exposed | 88.14 | 89.48 | 99.82 |
| 6 | 28% | exposed | 86.47 | 87.58 | 96.84 |
| 7.5 | 28% | exposed | 84.43 | 85.31 | 93.62 |
| 11.25 | 28% | exposed | 83.32 | 83.98 | 90.67 |
| 29 | 28% | exposed | 76.87 | 77.16 | 80.76 |
| 0 | 50% | exposed | 88.14 | 89.48 | 99.82 |
| 2 | 50% | exposed | 85.21 | 86.09 | 94.70 |
| 3.5 | 50% | exposed | 84.14 | 84.87 | 92.88 |
| 6 | 50% | exposed | 80.86 | 81.25 | 87.39 |
| 23 | 50% | exposed | 75.47 | 75.78 | 79.89 |

### Example I-7

Samples were prepared in same way as Example I-6, except the silver nitrate solution was prepared by placing 1.261 g silver nitrate and 200 g distilled water in a glass bottle. This resulting silver nitrate solution was approximately 4000 μg Ag/g. The initial color of the samples was white. The results from color monitoring experiments are shown in Table I-7.

TABLE I-7
Example I-7 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | exposed | 91.49 | 93.40 | 106.76 |
| 2 | 28% | exposed | 90.99 | 92.76 | 106.14 |
| 4 | 28% | exposed | 90.10 | 91.76 | 104.65 |
| 6 | 28% | exposed | 88.57 | 90.09 | 100.83 |
| 7.5 | 28% | exposed | 88.55 | 90.04 | 101.03 |
| 11.25 | 28% | exposed | 88.39 | 89.79 | 99.84 |
| 29 | 28% | exposed | 85.29 | 86.53 | 95.58 |
| 0 | 50% | exposed | 90.10 | 91.76 | 104.65 |
| 2 | 50% | exposed | 88.42 | 89.94 | 101.41 |
| 3.5 | 50% | exposed | 87.29 | 88.72 | 99.64 |
| 6 | 50% | exposed | 86.94 | 88.14 | 98.10 |
| 23 | 50% | exposed | 82.71 | 83.72 | 91.35 |

### Example I-8

### Comparative

Samples were prepared in same way as Example I-1, except the substrate was a 100% cotton non-woven from Suntec Union, Japan (Nissinbo, AN20601050 60 gsm, containing less than 50 ppm chloride). The initial color of the samples was off white. The results from color monitoring experiments are shown in Table I-8.

TABLE I-8
Example I-8 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 90.11 | 92.05 | 103.38 |
| 2 | 28% | in foil | 88.36 | 90.24 | 100.54 |
| 4 | 28% | in foil | 89.33 | 91.28 | 101.61 |
| 8 | 28% | in foil | 89.45 | 91.36 | 101.37 |
| 24 | 28% | in foil | 87.69 | 89.60 | 98.82 |
| 0 | 28% | exposed | 89.91 | 91.83 | 102.77 |
| 2 | 28% | exposed | 81.82 | 82.87 | 91.87 |
| 4 | 28% | exposed | 74.05 | 74.31 | 81.64 |
| 8 | 28% | exposed | 64.83 | 64.22 | 67.01 |
| 24 | 28% | exposed | 44.04 | 43.82 | 45.43 |
| 0 | 50% | exposed | 91.11 | 93.06 | 105.01 |
| 2 | 50% | exposed | 84.35 | 85.39 | 94.23 |
| 4 | 50% | exposed | 76.12 | 76.24 | 81.43 |
| 8 | 50% | exposed | 57.88 | 56.99 | 57.51 |
| 24 | 50% | exposed | 36.17 | 36.59 | 35.92 |

### Example I-9

### Comparative

Samples were prepared in same way as Example I-2, except the substrate was a 100% cotton non-woven from Suntec Union, Japan (Nissinbo, AN20601050 60 gsm, containing less than 50 ppm chloride). The initial color of the samples was off white. The results from color monitoring experiments are shown in Table I-9.

TABLE I-9
Example I-9 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 88.51 | 90.40 | 98.82 |
| 2 | 28% | in foil | 87.96 | 89.84 | 97.60 |
| 4 | 28% | in foil | 88.26 | 90.13 | 97.57 |
| 8 | 28% | in foil | 88.29 | 90.18 | 97.03 |
| 24 | 28% | in foil | 86.37 | 88.27 | 93.35 |
| 0 | 28% | exposed | 90.06 | 91.99 | 102.55 |
| 2 | 28% | exposed | 86.96 | 88.49 | 97.45 |
| 4 | 28% | exposed | 83.47 | 84.56 | 92.26 |
| 8 | 28% | exposed | 75.28 | 75.27 | 79.70 |
| 24 | 28% | exposed | 54.60 | 54.14 | 56.55 |
| 0 | 50% | exposed | 88.58 | 90.47 | 99.23 |
| 2 | 50% | exposed | 82.85 | 83.98 | 90.29 |
| 4 | 50% | exposed | 75.59 | 75.77 | 81.13 |
| 8 | 50% | exposed | 60.09 | 59.35 | 62.85 |
| 24 | 50% | exposed | 34.42 | 35.74 | 37.87 |

### Example I-10

### Comparative

Samples were prepared in same way as Example I-1, except the substrate was a non-woven of 70% Viscose/30% PET fibers (507030RPET P1, white, 50 gsm) from FA˜MA JERSEY s.p.a in Italy. The initial color of the samples was off white. The results from color monitoring experiments are shown in Table I-10.

TABLE I-10
Example I-10 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 81.37 | 82.74 | 86.19 |
| 2 | 28% | in foil | 80.15 | 81.31 | 84.22 |
| 4 | 28% | in foil | 81.30 | 82.52 | 86.23 |
| 8 | 28% | in foil | 80.10 | 81.18 | 84.08 |
| 24 | 28% | in foil | 78.68 | 79.73 | 82.21 |
| 0 | 28% | exposed | 84.09 | 85.69 | 90.95 |
| 2 | 28% | exposed | 40.47 | 41.03 | 45.52 |
| 4 | 28% | exposed | 34.16 | 34.53 | 38.44 |
| 8 | 28% | exposed | 27.04 | 27.02 | 29.61 |
| 24 | 28% | exposed | 22.53 | 22.32 | 23.17 |
| 0 | 50% | exposed | 83.47 | 84.96 | 88.89 |
| 2 | 50% | exposed | 36.60 | 36.75 | 40.03 |
| 4 | 50% | exposed | 30.65 | 30.61 | 33.06 |
| 8 | 50% | exposed | 24.80 | 24.51 | 24.75 |
| 24 | 50% | exposed | 19.87 | 19.56 | 16.79 |

### Example I-11

### Comparative

Samples were prepared in same way as Example I-2, except the substrate was a non-woven of 70% Viscose/30% PET fibers (507030RPET P1, white, 50 gsm) from FA˜MA JERSEY s.p.a in Italy. The initial color of the samples was off white. The results from color monitoring experiments are shown in Table I-11.

TABLE I-11
Example I-11 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 83.81 | 85.50 | 89.18 |
| 2 | 28% | in foil | 83.26 | 84.89 | 88.50 |
| 4 | 28% | in foil | 83.92 | 85.59 | 89.66 |
| 8 | 28% | in foil | 82.67 | 84.25 | 87.58 |
| 24 | 28% | in foil | 81.72 | 83.42 | 86.21 |
| 0 | 28% | exposed | 85.94 | 87.80 | 92.68 |
| 2 | 28% | exposed | 50.71 | 51.40 | 58.32 |
| 4 | 28% | exposed | 42.69 | 43.07 | 48.42 |
| 8 | 28% | exposed | 32.40 | 31.80 | 33.98 |
| 24 | 28% | exposed | 24.65 | 24.29 | 24.94 |
| 0 | 50% | exposed | 84.83 | 86.65 | 90.38 |
| 2 | 50% | exposed | 45.73 | 46.53 | 51.53 |
| 4 | 50% | exposed | 37.08 | 37.04 | 39.38 |
| 8 | 50% | exposed | 28.42 | 27.50 | 26.63 |
| 24 | 50% | exposed | 19.13 | 17.95 | 14.25 |

### Example I-12

### Comparative

Samples were prepared in same way as Example I-1, except the substrate was a non-woven of 70% LYOCELL fibers/30% PET (SX-156, white, 50 gsm, FT-10 apertured) from Ahlstrom Green Bay, Inc. in Green Bay, Wis. that contained less than 40 ppm chloride. The initial color of the samples was off white. The results from color monitoring experiments are shown in Table I-12.

TABLE I-12
Example I-12 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 82.78 | 83.66 | 90.59 |
| 2 | 28% | in foil | 82.40 | 83.23 | 90.07 |
| 4 | 28% | in foil | 82.70 | 83.49 | 90.27 |
| 8 | 28% | in foil | 82.50 | 83.21 | 89.90 |
| 24 | 28% | in foil | 80.46 | 81.05 | 87.50 |
| 0 | 28% | exposed | 84.02 | 85.04 | 91.42 |
| 2 | 28% | exposed | 41.48 | 41.60 | 46.75 |
| 4 | 28% | exposed | 32.67 | 32.97 | 38.11 |
| 8 | 28% | exposed | 28.61 | 29.01 | 33.61 |
| 24 | 28% | exposed | 23.99 | 24.36 | 28.34 |
| 0 | 50% | exposed | 84.96 | 86.10 | 93.01 |
| 2 | 50% | exposed | 40.73 | 40.84 | 46.51 |
| 4 | 50% | exposed | 33.88 | 34.04 | 39.12 |
| 8 | 50% | exposed | 29.17 | 29.43 | 33.70 |
| 24 | 50% | exposed | 25.38 | 25.52 | 27.80 |

### II.

### Example II-1

A silver nitrate coating solution was prepared by placing 0.0792 g silver nitrate (Aldrich Chemical Co., Milwaukee, Wis.) and 200 g distilled water in a glass bottle and capping the bottle and mixing at room temperature in a shaker overnight. Approximately 6 grams of this silver nitrate solution (approximately 250 μg Ag/g) solution was coated on a 4-inch×4-inch piece of 100% cotton non-woven from Suntec Union, Japan (Nissinbo, AN20601050 60 gsm, containing less than 50 ppm chloride) by transferring the solution by pipette to saturate the mesh that was contained in a polystyrene dish. Approximately one gram of coating solution dripped off of the mesh before the mesh was suspended in the oven for drying. Some additional solution dripped off the mesh in the oven (estimated at 1 g). The coated mesh was dried in a forced air oven (Memmert Universal Oven, available from Wisconsin Oven Company, East Troy Wisconsin) by heating at 105° C. for 12 minutes. The resulting material after drying was white in appearance. These coated samples were either wrapped in aluminum foil (protected from light), exposed to fluorescent light (Philips, F32T8/TL735, Universal/Hi-Vision, E4) in an environment of approximately 10-20% relative humidity environment, or exposed to fluorescent light (Philips, F32T8/TL735, Universal/Hi-Vision, K4) in an environment of 45-50% relative humidity. Color ratings of these samples were measured over time using a Minolta Chroma Meter (CR-300, manufactured by Konica Minolta Photo Imaging U.S.A., Inc., Mahwah, N.J.). The results are shown in Table II-1.

After the color stability test were completed, samples that were protected in foil and samples that were exposed to fluorescent light at 10-20% relative humidity were analyzed for silver ion release. Silver release from the aforementioned samples was measured in a solution of distilled water and sodium nitrate using a silver ion selective electrode (Orion, available VWR International, Batavia, Ill.). A sample of 0.1341 g that was exposed to light for 168 hr at approximately 20% relative humidity released 0.45 mg silver ion per gram of sample within 30 minutes of placing the sample in 98 grams distilled water and 2.96 grams of 5M sodium nitrate. By comparison, a 0.1140 g sample that was kept in foil during the 168 hours released 1.23 mg of silver ion per gram of sample into 98 grams of distilled water and 2.96 grams of sodium nitrate.

Total silver content measurements were also conducted in duplicate on coated sample that were kept in foil. For silver content, samples were first digested using nitric acid and hydrogen peroxide (See EPA Method 6010), and then total silver was measured using Inductively Coupled Plasma-Atomic Emission Spectroscopy (ICP-AES; Varian, Vista-Pro, AX). The average silver content was 1700 mg Ag/kg sample. Silver metal analysis was performed by first extracting a sample overnight with a 2.8% (w/w) ammonium carbonate solution at room temperature. The leachate was then discarded, and the samples were digested and silver content determined as above. For a sample that was kept in the foil, the silver metal content of the sample was 120 mg/kg sample.

TABLE II-1
Example II-1 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 87.06 | 89.1 | 94.7 |
| 2 | 12% | in foil | 87.72 | 89.78 | 95.72 |
| 4 | 11% | in foil | 87.64 | 89.71 | 95.25 |
| 8 | 12% | in foil | 87.48 | 89.55 | 95.18 |
| 24 | 11% | in foil | 87.88 | 89.96 | 95.82 |
| 48 | 10% | in foil | 88.22 | 90.26 | 96.36 |
| 120 | 16% | in foil | 87.86 | 89.92 | 95.7 |
| 168 | 18% | in foil | 87.23 | 89.32 | 94.6 |
| 0 | 12% | exposed | 86.35 | 88.3 | 92.01 |
| 2 | 12% | exposed | 86.04 | 87.89 | 92.59 |
| 4 | 11% | exposed | 85.94 | 84.68 | 92.96 |
| 8 | 12% | exposed | 84.49 | 86.08 | 91.04 |
| 24 | 11% | exposed | 82.21 | 83.44 | 88.22 |
| 48 | 10% | exposed | 77.79 | 78.39 | 82.1 |
| 120 | 16% | exposed | 68.61 | 69.08 | 71.7 |
| 168 | 18% | exposed | 65.85 | 66.99 | 68.05 |
| 0 | 49% | exposed | 86.51 | 88.49 | 92.2 |
| 2 | 49% | exposed | 86.08 | 87.89 | 92.25 |
| 4 | 49% | exposed | 84.66 | 86.1 | 90.86 |
| 8 | 48% | exposed | 78.49 | 79.18 | 81.62 |
| 24 | 47% | exposed | 59.77 | 60.04 | 61.67 |
| 48 | 47% | exposed | 47.43 | 48.48 | 49.18 |
| 120 | 47% | exposed | 39.56 | 40.73 | 36.79 |
| 168 | 47% | exposed | 36.64 | 37.83 | 33.51 |

### Example II-2

### Control

The color ratings over time of the uncoated cotton substrate used in Example II-1 were also measured. These results are included in Table II-2.

TABLE II-2
Example II-2 (Control)-Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 92.55 | 94.58 | 107.96 |
| 2 | 12% | in foil | 92.55 | 94.53 | 107.93 |
| 4 | 11% | in foil | 92.42 | 94.37 | 107.9 |
| 8 | 12% | in foil | 92.57 | 94.54 | 108.2 |
| 24 | 11% | in foil | 92.53 | 94.54 | 107.99 |
| 48 | 10% | in foil | 92.85 | 94.83 | 108.54 |
| 120 | 16% | in foil | 92.9 | 94.88 | 108.61 |
| 168 | 18% | in foil | 92.6 | 94.65 | 108.2 |

### Example II-3

### Comparative

The color ratings over time of a commercially available wound dressing were also measured during exposure to light. This commercially available wound dressing, available under the tradename AQUACEL Ag, Lot 5F05519, from ConvaTec, contains silver chloride/silver alginate with high levels of chloride which acts as a stabilizer and has an initial off-white color. During exposure to light, the color of the sample became noticeably gray. The results from these experiments are shown in Table II-3.

TABLE II-3
Example II-3 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 53.51 | 53.75 | 64.21 |
| 2 | 12% | in foil | 53.03 | 53.30 | 63.85 |
| 4 | 11% | in foil | 52.90 | 53.22 | 63.91 |
| 8 | 12% | in foil | 53.40 | 53.73 | 64.41 |
| 24 | 11% | in foil | 53.53 | 53.66 | 64.44 |
| 48 | 10% | in foil | 53.41 | 53.74 | 64.57 |
| 120 | 16% | in foil | 52.31 | 52.61 | 63.28 |
| 168 | 18% | in foil | 52.67 | 53.01 | 63.60 |
| 0 | 12% | exposed | 51.75 | 52.09 | 62.71 |
| 2 | 12% | exposed | 47.28 | 47.81 | 57.76 |
| 4 | 11% | exposed | 46.20 | 46.58 | 55.52 |
| 8 | 12% | exposed | 44.79 | 45.29 | 53.37 |
| 24 | 11% | exposed | 43.30 | 43.60 | 50.25 |
| 48 | 10% | exposed | 41.44 | 41.67 | 47.11 |
| 120 | 16% | exposed | 39.12 | 39.41 | 44.70 |
| 168 | 18% | exposed | 38.12 | 38.46 | 43.78 |
| 0 | 49% | exposed | 53.06 | 53.37 | 63.67 |
| 2 | 49% | exposed | 47.16 | 47.76 | 58.26 |
| 4 | 49% | exposed | 45.63 | 46.09 | 55.69 |
| 8 | 48% | exposed | 44.07 | 44.48 | 53.31 |
| 24 | 47% | exposed | 40.91 | 41.25 | 48.51 |
| 48 | 47% | exposed | 38.62 | 38.85 | 44.85 |
| 120 | 47% | exposed | 36.54 | 36.49 | 41.75 |
| 168 | 47% | exposed | 34.53 | 34.42 | 39.59 |

### Example II-4

Samples were prepared in same way as Example II-1, except the silver nitrate solution was prepared by placing 0.316 g silver nitrate and 200 g distilled water in a glass bottle. This resulting silver nitrate solution was approximately 1000 μg Ag/g. The color of the samples was off-white. The results from color monitoring experiments are shown in Table II-4.

Silver ion release and total silver content measurements were conducted as described in Example II-1. An amount of 0.1320 grams of the sample that was exposed to light for 168 hr at approximately 20% relative humidity released 4.46 mg silver ion per gram of sample within 30 minutes of placing the sample in 98 grams distilled water and 2.96 grams of 5M sodium nitrate. By comparison, a 0.1626 g sample that was kept in foil during the 168 hours released 5.21 mg of silver ion per gram of sample into 98 grams of distilled water and 2.96 grams of sodium nitrate. The average total silver content was 6950 mg Ag/kg sample. The silver metal content was 350 mg/kg sample.

TABLE II-4
Example II-4 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 80.95 | 82.71 | 80.89 |
| 2 | 12% | in foil | 80.80 | 82.54 | 80.47 |
| 4 | 11% | in foil | 81.81 | 83.56 | 81.88 |
| 8 | 12% | in foil | 81.12 | 82.82 | 80.73 |
| 24 | 11% | in foil | 81.23 | 82.93 | 80.77 |
| 48 | 10% | in foil | 81.15 | 82.85 | 80.58 |
| 120 | 16% | in foil | 81.01 | 82.7 | 80.37 |
| 168 | 18% | in foil | 80.82 | 82.51 | 79.83 |
| 0 | 12% | exposed | 81.13 | 82.87 | 82.42 |
| 2 | 12% | exposed | 81.07 | 82.79 | 81.84 |
| 4 | 11% | exposed | 80.91 | 82.53 | 82.16 |
| 8 | 12% | exposed | 79.77 | 81.24 | 80.65 |
| 24 | 11% | exposed | 77.4 | 78.46 | 75.52 |
| 48 | 10% | exposed | 72.71 | 73.19 | 68.73 |
| 120 | 16% | exposed | 60.66 | 60.53 | 53.36 |
| 168 | 18% | exposed | 51.71 | 51.63 | 44.89 |
| 0 | 49% | exposed | 81.53 | 83.26 | 81.2 |
| 2 | 49% | exposed | 79.98 | 81.49 | 78.29 |
| 4 | 49% | exposed | 78.76 | 80.02 | 76.25 |
| 8 | 48% | exposed | 75.06 | 75.86 | 71.43 |
| 24 | 47% | exposed | 59.73 | 60.29 | 55.57 |
| 48 | 47% | exposed | 48.01 | 48.98 | 43.13 |
| 120 | 47% | exposed | 30.68 | 30.97 | 20.96 |
| 168 | 47% | exposed | 27.78 | 27.99 | 18.12 |

### Example II-5

Samples were prepared in same way as Example II-1, except the drying temperature was 130° C. The color of the samples was cream (light yellow). The results from color monitoring experiments are shown in Table II-5.

Silver ion release and total silver content measurements were conducted as described in Example II-1. An amount of 0.1341 grams of the sample that was exposed to light for 168 hr at approximately 20% relative humidity released 0.49 mg silver ion per gram of sample within 30 minutes of placing the sample in 98 grams distilled water and 2.96 grams of 5M sodium nitrate. By comparison, a 0.1280 g sample that was kept in foil during the 168 hours released 1.06 mg of silver ion per gram of sample into 98 grams of distilled water and 2.96 grams of sodium nitrate. The average total silver content was 2000 mg Ag/kg sample. The silver metal content was 160 mg/kg sample.

TABLE II-5
Example II-5 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 69.49 | 70.83 | 48.26 |
| 2 | 12% | in foil | 70.01 | 71.37 | 48.99 |
| 4 | 11% | in foil | 69.90 | 71.23 | 48.73 |
| 8 | 12% | in foil | 69.32 | 70.57 | 47.78 |
| 24 | 11% | in foil | 69.76 | 71.02 | 48.57 |
| 48 | 10% | in foil | 69.68 | 70.92 | 48.05 |
| 120 | 16% | in foil | 69.53 | 70.73 | 48.18 |
| 168 | 18% | in foil | 69.56 | 70.83 | 48.09 |
| 0 | 12% | exposed | 69.00 | 70.17 | 48.40 |
| 2 | 12% | exposed | 68.53 | 69.63 | 48.37 |
| 4 | 11% | exposed | 68.82 | 69.91 | 48.72 |
| 8 | 12% | exposed | 67.16 | 68.08 | 46.75 |
| 24 | 11% | exposed | 65.74 | 66.32 | 45.88 |
| 48 | 10% | exposed | 63.61 | 63.80 | 44.50 |
| 120 | 16% | exposed | 55.74 | 55.41 | 38.01 |
| 168 | 18% | exposed | 50.82 | 50.69 | 35.80 |
| 0 | 49% | exposed | 68.68 | 69.72 | 50.85 |
| 2 | 49% | exposed | 66.61 | 67.34 | 47.24 |
| 4 | 49% | exposed | 65.34 | 65.81 | 45.74 |
| 8 | 48% | exposed | 62.47 | 62.50 | 44.00 |
| 24 | 47% | exposed | 51.69 | 50.97 | 37.77 |
| 48 | 47% | exposed | 41.88 | 42.00 | 33.19 |
| 120 | 47% | exposed | 35.46 | 36.24 | 28.98 |
| 168 | 47% | exposed | 31.18 | 31.89 | 26.85 |

### Example II-6

Samples were prepared in same way as Example II-4, except the drying temperature was 130° C. The color of the samples was light yellow. The results from color monitoring experiments are shown in Table II-6.

Silver ion release and total silver content measurements were conducted as described in Example II-1. An amount of 0.1376 g of the sample that was exposed to light for 168 hr at approximately 20% relative humidity released 4.28 mg silver ion per gram of sample within 30 minutes of placing the sample in 98 grams distilled water and 2.96 grams of 5M sodium nitrate. By comparison, a 0.1462 gram sample that was kept in foil during the 168 hours released 5.18 mg of silver ion per gram of sample into 98 grams of distilled water and 2.96 grams of sodium nitrate. The average total silver content was 7650 mg Ag/kg sample. The silver metal content was 530 mg/kg sample.

TABLE II-6
Example II-6 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 55.09 | 54.35 | 32.83 |
| 2 | 12% | in foil | 54.89 | 54.13 | 32.89 |
| 4 | 11% | in foil | 55.37 | 54.65 | 33.23 |
| 8 | 12% | in foil | 54.72 | 53.98 | 32.83 |
| 24 | 11% | in foil | 55.50 | 54.77 | 33.61 |
| 48 | 10% | in foil | 55.83 | 55.14 | 33.67 |
| 120 | 16% | in foil | 56.72 | 56.16 | 34.03 |
| 168 | 18% | in foil | 55.71 | 55.05 | 33.62 |
| 0 | 12% | exposed | 57.41 | 57.16 | 36.86 |
| 2 | 12% | exposed | 57.39 | 57.18 | 37.32 |
| 4 | 11% | exposed | 58.53 | 58.32 | 37.92 |
| 8 | 12% | exposed | 56.98 | 56.66 | 36.61 |
| 24 | 11% | exposed | 56.42 | 55.93 | 35.89 |
| 48 | 10% | exposed | 54.61 | 53.86 | 33.79 |
| 120 | 16% | exposed | 50.06 | 48.96 | 30.27 |
| 168 | 18% | exposed | 45.73 | 44.54 | 27.05 |
| 0 | 49% | exposed | 55.70 | 54.92 | 32.57 |
| 2 | 49% | exposed | 55.72 | 54.96 | 31.58 |
| 4 | 49% | exposed | 54.78 | 53.85 | 30.23 |
| 8 | 48% | exposed | 53.14 | 52.06 | 29.52 |
| 24 | 47% | exposed | 48.62 | 47.21 | 25.68 |
| 48 | 47% | exposed | 39.26 | 38.29 | 21.27 |
| 120 | 47% | exposed | 26.10 | 24.96 | 14.83 |
| 168 | 47% | exposed | 23.89 | 22.17 | 11.66 |

### Example II-7

Samples were prepared in same way as Example II-1, except the drying temperature was 155° C. The color of the samples was yellow. The results from color monitoring experiments are shown in Table II-7.

Silver ion release and total silver content measurements were conducted as described in Example II-1. An amount of 0.1426 grams of the sample that was exposed to light for 168 hr at approximately 20% relative humidity released 0.31 mg silver ion per gram of sample within 30 minutes of placing the sample in 98 grams distilled water and 2.96 grams of 5M sodium nitrate. By comparison, a 0.1307 g sample that was kept in foil during the 168 hours released 0.95 mg of silver ion per gram of sample into 98 grams of distilled water and 2.96 grams of sodium nitrate. The average total silver content was 1850 mg Ag/kg sample. The silver metal content was 250 mg/kg sample.

TABLE II-7
Example II-7 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 57.24 | 57.13 | 28.24 |
| 2 | 12% | in foil | 56.37 | 56.15 | 27.74 |
| 4 | 11% | in foil | 59.84 | 60.15 | 30.51 |
| 8 | 12% | in foil | 59.49 | 59.72 | 30.29 |
| 24 | 11% | in foil | 59.78 | 60.01 | 30.63 |
| 48 | 10% | in foil | 58.90 | 59.02 | 29.69 |
| 120 | 16% | in foil | 59.27 | 59.34 | 30.30 |
| 168 | 18% | in foil | 60.24 | 60.47 | 31.04 |
| 0 | 12% | exposed | 55.48 | 55.08 | 28.47 |
| 2 | 12% | exposed | 55.62 | 55.20 | 28.86 |
| 4 | 11% | exposed | 55.59 | 55.09 | 28.40 |
| 8 | 12% | exposed | 55.11 | 54.60 | 28.20 |
| 24 | 11% | exposed | 53.33 | 52.59 | 27.03 |
| 48 | 10% | exposed | 53.40 | 52.66 | 27.73 |
| 120 | 16% | exposed | 50.43 | 49.57 | 26.12 |
| 168 | 18% | exposed | 46.73 | 45.74 | 23.78 |
| 0 | 49% | exposed | 59.25 | 59.66 | 33.23 |
| 2 | 49% | exposed | 58.72 | 58.97 | 32.67 |
| 4 | 49% | exposed | 58.63 | 58.92 | 32.40 |
| 8 | 48% | exposed | 57.94 | 58.22 | 31.47 |
| 24 | 47% | exposed | 55.49 | 55.46 | 30.25 |
| 48 | 47% | exposed | 53.18 | 53.3 | 28.88 |
| 120 | 47% | exposed | 45.51 | 45.67 | 26.09 |
| 168 | 47% | exposed | 39.02 | 39.03 | 25.11 |

### Example II-8

Samples were prepared in same way as Example II-4, except the drying temperature was 155° C. The color of the samples was yellow. The results from color monitoring experiments are shown in Table II-8.

Silver ion release and total silver content measurements were conducted as described in Example II-1. An amount of 0.1366 g of the sample that was exposed to light for 168 hr at approximately 20% relative humidity released 2.49 mg silver ion per gram of sample within 30 minutes of placing the sample in 98 grams distilled water and 2.96 grams of 5M sodium nitrate. By comparison, a 0.1351 g sample that was kept in foil during the 168 hours released 4.97 mg of silver ion per gram of sample into 98 grams of distilled water and 2.96 grams of sodium nitrate. The average total silver content was 6900 mg Ag/kg sample. The silver metal content was 900 mg/kg sample.

TABLE II-8
Example II-8 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 42.65 | 41.24 | 19.00 |
| 2 | 12% | in foil | 42.95 | 41.49 | 18.57 |
| 4 | 11% | in foil | 43.07 | 41.59 | 18.71 |
| 8 | 12% | in foil | 43.22 | 41.73 | 19.15 |
| 24 | 11% | in foil | 43.25 | 41.76 | 18.85 |
| 48 | 10% | in foil | 43.40 | 41.90 | 19.05 |
| 120 | 16% | in foil | 43.98 | 42.50 | 19.43 |
| 168 | 18% | in foil | 43.88 | 42.40 | 19.27 |
| 0 | 12% | exposed | 43.55 | 45.33 | 18.81 |
| 2 | 12% | exposed | 44.10 | 42.86 | 19.08 |
| 4 | 11% | exposed | 43.80 | 42.56 | 18.89 |
| 8 | 12% | exposed | 43.29 | 41.99 | 18.44 |
| 24 | 11% | exposed | 42.88 | 41.53 | 18.91 |
| 48 | 10% | exposed | 42.11 | 40.70 | 17.65 |
| 120 | 16% | exposed | 39.80 | 38.31 | 16.75 |
| 168 | 18% | exposed | 36.54 | 35.29 | 16.27 |
| 0 | 49% | exposed | 42.34 | 40.96 | 18.32 |
| 2 | 49% | exposed | 43.11 | 41.64 | 17.39 |
| 4 | 49% | exposed | 42.19 | 40.68 | 17.74 |
| 8 | 48% | exposed | 41.40 | 39.90 | 17.04 |
| 24 | 47% | exposed | 38.31 | 36.62 | 16.24 |
| 48 | 47% | exposed | 33.94 | 32.50 | 13.97 |
| 120 | 47% | exposed | 26.01 | 24.71 | 10.66 |
| 168 | 47% | exposed | 23.28 | 21.99 | 10.32 |

### Example II-9

Samples were prepared in same way as Example II-8, except the silver nitrate solution was prepared by placing 0.632 g silver nitrate and 200 g distilled water in a glass bottle. This resulting silver nitrate solution was approximately 2000 μg Ag/g. The color of the samples was golden yellow. The results from color monitoring experiments are shown in Table II-9.

Silver ion release and total silver content measurements were conducted as described in Example II-1. An amount of 0.1308 g of the sample that was exposed to light for 168 hr at approximately 20% relative humidity released 9.2 mg silver ion per gram of sample within 30 minutes of placing the sample in 98 grams distilled water and 2.96 grams of 5M sodium nitrate. By comparison, a 0.1431 g sample that was kept in foil during the 168 hours released 10.8 mg of silver ion per gram of sample into 98 grams of distilled water and 2.96 grams of sodium nitrate. The average total silver content was 16,000 mg Ag/kg sample. The silver metal content was 1400 mg/kg sample.

TABLE II-9
Example II-9 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 41.74 | 40.74 | 19.36 |
| 2 | 12% | in foil | 41.63 | 40.58 | 19.29 |
| 4 | 11% | in foil | 41.48 | 40.54 | 19.99 |
| 8 | 12% | in foil | 42.00 | 40.91 | 19.51 |
| 24 | 11% | in foil | 42.41 | 41.35 | 19.55 |
| 48 | 10% | in foil | 42.21 | 41.18 | 19.83 |
| 120 | 16% | in foil | 42.31 | 41.29 | 19.98 |
| 168 | 18% | in foil | 42.98 | 41.99 | 20.03 |
| 0 | 12% | exposed | 40.59 | 39.38 | 18.64 |
| 2 | 12% | exposed | 40.89 | 39.71 | 19.49 |
| 4 | 11% | exposed | 40.95 | 39.76 | 20.07 |
| 8 | 12% | exposed | 40.05 | 38.84 | 19.99 |
| 24 | 11% | exposed | 40.65 | 39.33 | 18.52 |
| 48 | 10% | exposed | 40.20 | 38.89 | 18.66 |
| 120 | 16% | exposed | 38.79 | 37.25 | 16.35 |
| 168 | 18% | exposed | 36.05 | 34.41 | 16.96 |
| 0 | 49% | exposed | 40.24 | 39.12 | 19.14 |
| 2 | 49% | exposed | 40.54 | 39.19 | 17.30 |
| 4 | 49% | exposed | 41.31 | 40.15 | 18.37 |
| 8 | 48% | exposed | 40.61 | 39.35 | 17.70 |
| 24 | 47% | exposed | 38.43 | 36.78 | 15.89 |
| 48 | 47% | exposed | 34.27 | 32.43 | 13.77 |
| 120 | 47% | exposed | 24.06 | 21.72 | 10.56 |
| 168 | 47% | exposed | 21.06 | 18.68 | 9.53 |

### Example II-10

Samples were prepared in same way as Example II-8, except the silver solution was silver benzoate (Alfa Aesar; Ward Hill, Mass.), which was prepared by placing 0.230 g silver benzoate and 200 g distilled water in a glass bottle. This resulting silver benzoate solution was approximately 500 μg Ag/g. The color of the samples was yellow. The results from color monitoring experiments are shown in Table II-10.

Silver ion release and total silver content measurements were conducted as described in Example II-1. An amount of 0.1341 g of the sample that was exposed to light for 168 hr at approximately 20% relative humidity released 0.22 mg silver ion per gram of sample within 30 minutes of placing the sample in 98 grams distilled water and 2.96 grams of 5M sodium nitrate. By comparison, a 0.1323 g sample that was kept in foil during the 168 hours released 0.71 mg of silver ion per gram of sample into 98 grams of distilled water and 2.96 grams of sodium nitrate. The average total silver content was 3350 mg Ag/kg sample.

TABLE II-10
Example II-10 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 41.83 | 41.21 | 18.15 |
| 2 | 12% | in foil | 42.09 | 41.5 | 18.44 |
| 4 | 11% | in foil | 42.19 | 41.65 | 18.64 |
| 8 | 12% | in foil | 42.27 | 41.71 | 18.61 |
| 24 | 11% | in foil | 42.27 | 41.72 | 19.44 |
| 48 | 10% | in foil | 42.28 | 41.7 | 19.06 |
| 120 | 16% | in foil | 42.57 | 41.82 | 18.63 |
| 168 | 18% | in foil | 42.55 | 41.84 | 19.14 |
| 0 | 12% | exposed | 42.94 | 42.37 | 18.87 |
| 2 | 12% | exposed | 42.19 | 41.67 | 19.99 |
| 4 | 11% | exposed | 42.07 | 41.57 | 19.87 |
| 8 | 12% | exposed | 42.27 | 41.81 | 19.65 |
| 24 | 11% | exposed | 42.05 | 41.6 | 19.25 |
| 48 | 10% | exposed | 41.78 | 41.33 | 19.82 |
| 120 | 16% | exposed | 42.19 | 41.68 | 20.01 |
| 168 | 18% | exposed | 42.12 | 41.58 | 19.92 |
| 0 | 49% | exposed | 41.04 | 40.65 | 19.67 |
| 2 | 49% | exposed | 41.85 | 41.34 | 18.70 |
| 4 | 49% | exposed | 40.04 | 39.42 | 19.00 |
| 8 | 48% | exposed | 39.79 | 39.11 | 18.73 |
| 24 | 47% | exposed | 39.86 | 39.11 | 18.04 |
| 48 | 47% | exposed | 39.21 | 38.24 | 17.61 |
| 120 | 47% | exposed | 38.06 | 37.14 | 17.32 |
| 168 | 47% | exposed | 36.47 | 35.68 | 17.83 |

### Example II-11

Samples were prepared in same way as Example II-10, except the silver solution was silver benzoate and this solution was prepared by placing 0.459 g silver benzoate and 200 g distilled water in a glass bottle. This resulting silver benzoate solution was approximately 1000 μg Ag/g. The color of the samples was yellow. The results from color monitoring experiments are shown in Table II-11.

Silver ion release and total silver content measurements were conducted as described in Example II-1. An amount of 0.1352 g of the sample that was exposed to light for 168 hr at approximately 20% relative humidity released 0.80 mg silver ion per gram of sample within 30 minutes of placing the sample in 98 grams distilled water and 2.96 grams of 5M sodium nitrate. By comparison, a 0.1502 g sample that was kept in foil during the 168 hours released 1.50 mg of silver ion per gram of sample into 98 grams of distilled water and 2.96 grams of sodium nitrate. The average total silver content was 6750 mg Ag/kg sample.

TABLE II-11
Example II-11 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 31.49 | 30.33 | 13.40 |
| 2 | 12% | in foil | 32.21 | 31.07 | 13.62 |
| 4 | 11% | in foil | 32.49 | 31.36 | 13.49 |
| 8 | 12% | in foil | 32.37 | 31.18 | 13.72 |
| 24 | 11% | in foil | 32.32 | 31.14 | 13.74 |
| 48 | 10% | in foil | 32.44 | 31.21 | 13.46 |
| 120 | 16% | in foil | 32.64 | 31.38 | 13.61 |
| 168 | 18% | in foil | 32.36 | 31.07 | 13.82 |
| 0 | 12% | exposed | 32.48 | 31.33 | 13.78 |
| 2 | 12% | exposed | 32.21 | 31.05 | 13.34 |
| 4 | 11% | exposed | 32.01 | 30.85 | 13.26 |
| 8 | 12% | exposed | 32.30 | 31.19 | 13.56 |
| 24 | 11% | exposed | 31.73 | 30.64 | 13.32 |
| 48 | 10% | exposed | 31.63 | 30.57 | 13.56 |
| 120 | 16% | exposed | 31.57 | 30.43 | 13.30 |
| 168 | 18% | exposed | 31.69 | 30.53 | 13.37 |
| 0 | 49% | exposed | 33.00 | 31.91 | 13.92 |
| 2 | 49% | exposed | 32.78 | 31.55 | 12.98 |
| 4 | 49% | exposed | 32.73 | 31.47 | 13.07 |
| 8 | 48% | exposed | 32.31 | 31.06 | 13.34 |
| 24 | 47% | exposed | 32.32 | 30.94 | 12.76 |
| 48 | 47% | exposed | 31.23 | 29.74 | 12.45 |
| 120 | 47% | exposed | 29.81 | 28.41 | 11.76 |
| 168 | 47% | exposed | 28.60 | 27.49 | 12.22 |

### Example II-12

Samples were prepared in same way as Example II-11, except the substrate was a non-woven of 100% TENCEL fibers (SX-152, white, 65 gsm, 24 mesh, from Green Bay Nonwovens, Inc. in Green Bay, Wis.) that contained less than 40 ppm chloride. The color of the samples was golden brown. The results from color monitoring experiments are shown in Table II-12.

Silver ion release and total silver content measurements were conducted as described in Example II-1. An amount of 0.1662 g of the sample that was exposed to light for 168 hr at approximately 20% relative humidity released 1.61 mg silver ion per gram of sample within 30 minutes of placing the sample in 98 grams distilled water and 2.96 grams of 5M sodium nitrate. By comparison, a 0.1524 g sample that was kept in foil during the 168 hours released 2.34 mg of silver ion per gram of sample into 98 grams of distilled water and 2.96 grams of sodium nitrate. The average total silver content was 7650 mg Ag/kg sample.

TABLE II-12
Example II-12 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 22.92 | 21.10 | 6.51 |
| 2 | 12% | in foil | 22.88 | 21.02 | 6.43 |
| 4 | 11% | in foil | 22.58 | 20.73 | 6.32 |
| 8 | 12% | in foil | 22.94 | 21.09 | 6.35 |
| 24 | 11% | in foil | 22.91 | 21.06 | 6.30 |
| 48 | 10% | in foil | 23.00 | 21.12 | 6.26 |
| 120 | 16% | in foil | 22.88 | 20.96 | 6.15 |
| 168 | 18% | in foil | 23.60 | 21.63 | 6.52 |
| 0 | 12% | exposed | 22.97 | 21.26 | 6.68 |
| 2 | 12% | exposed | 23.83 | 22.10 | 6.68 |
| 4 | 11% | exposed | 24.22 | 22.52 | 6.88 |
| 8 | 12% | exposed | 24.08 | 22.38 | 6.82 |
| 24 | 11% | exposed | 24.40 | 22.75 | 6.86 |
| 48 | 10% | exposed | 24.26 | 22.61 | 6.83 |
| 120 | 16% | exposed | 23.40 | 21.79 | 6.88 |
| 168 | 18% | exposed | 24.39 | 22.71 | 6.88 |
| 0 | 49% | exposed | 23.00 | 21.19 | 6.54 |
| 2 | 49% | exposed | 22.42 | 20.68 | 6.19 |
| 4 | 49% | exposed | 21.15 | 19.56 | 6.05 |
| 8 | 48% | exposed | 20.44 | 19.02 | 6.13 |
| 24 | 47% | exposed | 18.46 | 17.48 | 6.03 |
| 48 | 47% | exposed | 17.00 | 16.42 | 6.06 |
| 120 | 47% | exposed | 15.90 | 15.79 | 6.48 |
| 168 | 47% | exposed | 16.04 | 16.07 | 6.91 |

### Example II-13

Samples were prepared in same way as Example II-4, except the drying temperature was 180° C. The color of the samples was golden yellow. The results from color monitoring experiments are shown in Table II-13.

Silver ion release and total silver content measurements were conducted as described in Example II-1. An amount of 0.1476 g of the sample that was exposed to light for 168 hr at approximately 20% relative humidity released 0.44 mg silver ion per gram of sample within 30 minutes of placing the sample in 98 grams distilled water and 2.96 grams of 5M sodium nitrate. By comparison, a 0.1550 g sample that was kept in foil during the 168 hours released 0.88 mg of silver ion per gram of sample into 98 grams of distilled water and 2.96 grams of sodium nitrate. The average total silver content was 6900 mg Ag/kg sample. The silver metal content was 1200 mg/kg sample.

TABLE II-13
Example II-13 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 30.67 | 29.37 | 9.41 |
| 2 | 12% | in foil | 31.03 | 29.79 | 9.95 |
| 4 | 11% | in foil | 31.08 | 29.83 | 9.98 |
| 8 | 12% | in foil | 31.09 | 29.90 | 9.90 |
| 24 | 11% | in foil | 31.17 | 29.92 | 9.95 |
| 48 | 10% | in foil | 31.10 | 29.81 | 9.88 |
| 120 | 16% | in foil | 31.19 | 29.81 | 9.98 |
| 168 | 18% | in foil | 31.24 | 29.85 | 10.07 |
| 0 | 12% | exposed | 30.09 | 28.75 | 10.25 |
| 2 | 12% | exposed | 30.34 | 28.93 | 9.95 |
| 4 | 11% | exposed | 30.02 | 28.60 | 10.13 |
| 8 | 12% | exposed | 29.49 | 28.15 | 10.48 |
| 24 | 11% | exposed | 29.50 | 28.11 | 10.35 |
| 48 | 10% | exposed | 29.38 | 28.02 | 10.58 |
| 120 | 16% | exposed | 29.12 | 27.95 | 10.81 |
| 168 | 18% | exposed | 27.98 | 26.98 | 10.64 |
| 0 | 49% | exposed | 33.28 | 32.32 | 11.46 |
| 2 | 49% | exposed | 34.46 | 33.41 | 11.48 |
| 4 | 49% | exposed | 34.49 | 33.44 | 11.48 |
| 8 | 48% | exposed | 33.89 | 32.85 | 11.26 |
| 24 | 47% | exposed | 33.50 | 32.57 | 11.44 |
| 48 | 47% | exposed | 32.46 | 31.58 | 11.08 |
| 120 | 47% | exposed | 30.71 | 30.02 | 10.93 |
| 168 | 47% | exposed | 30.15 | 29.55 | 10.82 |

### Example II-14

Samples were prepared in same way as Example II-10, except the silver solution was comprised of 0.127 g of silver carbonate (Alfa Aesar, Ward Hill, Mass.), 0.48 g of ammonium carbonate (Mallinckroft Baker, Inc.; Phillipsburg, N.J.), and 100 g distilled water. The color of the coated cotton samples was golden yellow. The results from color monitoring experiments are shown in Table II-14.

Silver ion release and total silver content measurements were conducted as described in Example II-1. An amount of 0.1386 g of the sample that was exposed to light for 168 hr at approximately 20% relative humidity released 0.44 mg silver ion per gram of sample within 30 minutes of placing the sample in 98 grams distilled water and 2.96 grams of 5M sodium nitrate. By comparison, a 0.1498 g sample that was kept in foil during the 168 hours released 0.48 mg of silver ion per gram of sample into 98 grams of distilled water and 2.96 grams of sodium nitrate. The average total silver content was 8150 mg Ag/kg sample.

TABLE II-14
Example II-14 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 34.39 | 32.41 | 12.16 |
| 2 | 12% | in foil | 34.87 | 33.16 | 12.96 |
| 4 | 11% | in foil | 34.95 | 33.32 | 13.79 |
| 8 | 12% | in foil | 35.40 | 33.71 | 13.74 |
| 24 | 11% | in foil | 34.94 | 33.01 | 12.97 |
| 48 | 10% | in foil | 34.48 | 32.62 | 13.61 |
| 120 | 16% | in foil | 34.28 | 32.23 | 13.50 |
| 168 | 18% | in foil | 34.30 | 31.99 | 12.57 |
| 0 | 12% | exposed | 31.50 | 29.39 | 10.26 |
| 2 | 12% | exposed | 30.83 | 28.74 | 10.04 |
| 4 | 11% | exposed | 32.22 | 30.21 | 10.55 |
| 8 | 12% | exposed | 31.59 | 29.50 | 10.23 |
| 24 | 11% | exposed | 31.64 | 29.44 | 10.42 |
| 48 | 10% | exposed | 32.02 | 29.80 | 10.32 |
| 120 | 16% | exposed | 31.69 | 29.43 | 10.21 |
| 168 | 18% | exposed | 31.98 | 29.75 | 10.22 |
| 0 | 49% | exposed | 30.65 | 28.7 | 10.66 |
| 2 | 49% | exposed | 30.23 | 28.08 | 9.90 |
| 4 | 49% | exposed | 30.60 | 28.47 | 10.17 |
| 8 | 48% | exposed | 30.41 | 28.29 | 10.15 |
| 24 | 47% | exposed | 30.65 | 28.61 | 10.64 |
| 48 | 47% | exposed | 30.88 | 28.85 | 10.31 |
| 120 | 47% | exposed | 30.69 | 28.68 | 10.35 |
| 168 | 47% | exposed | 30.80 | 28.86 | 10.35 |

### Example II-15

Samples were prepared in same way as Example II-10, except the silver solution was silver acetate and this solution was prepared by placing 0.309 g silver acetate (Matheson, Coleman, and Bell; Norwood, Ohio) and 200 g distilled water in a glass bottle, and the drying temperature was 170° C. This resulting silver acetate solution was approximately 1000 μg Ag/g. The color of the samples was yellow. The results from color monitoring experiments are shown in Table II-15.

Silver ion release measurements were conducted as described in Example II-1. An amount of 0.1525 g of the sample that was exposed to light for at least 14 days at approximately 20% relative humidity released 0.71 mg silver ion per gram of sample within 30 minutes of placing the sample in 98 grams distilled water and 2.96 grams of 5M sodium nitrate. By comparison, a 0.1528 g sample that was kept foil for during the experiment released 0.69 mg of silver ion per gram of sample into 98 grams of distilled water and 2.96 grams of sodium nitrate.

TABLE II-15
Example II-15 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 1 | 20% | in foil | 34.89 | 33.37 | 12.36 |
| 9 | 18% | in foil | 31.11 | 29.48 | 12.31 |
| 14 | 12% | in foil | 36.99 | 35.59 | 13.20 |
| 17 | 14% | in foil | 35.21 | 33.93 | 14.10 |
| 1 | 20% | exposed | 32.48 | 31.33 | 13.78 |
| 9 | 18% | exposed | 32.21 | 31.05 | 13.34 |
| 14 | 12% | exposed | 32.01 | 30.85 | 13.26 |
| 17 | 14% | exposed | 32.30 | 31.19 | 13.56 |
| 1 | 50% | exposed | 28.56 | 26.95 | 10.11 |
| 9 | 50% | exposed | 28.45 | 26.90 | 10.74 |
| 14 | 50% | exposed | 28.14 | 26.57 | 10.22 |
| 17 | 50% | exposed | 27.56 | 26.15 | 11.24 |

### Example II-16

Samples were prepared in same way as Example II-1, except the silver nitrate solution was prepared by placing 0.632 g silver nitrate and 200 g distilled water in a glass bottle. This resulting silver nitrate solution was approximately 2000 μg Ag/g. The color of the samples was off-white. The results from color monitoring experiments are shown in Table II-16.

Silver ion release and total silver content measurements were conducted as described in Example II-1. An amount of 0.1516 g of the sample that was exposed to light for 168 hr at approximately 20% relative humidity released 10.6 mg silver ion per gram of sample within 30 minutes of placing the sample in 98 grams distilled water and 2.96 grams of 5M sodium nitrate. By comparison, a 0.1368 g sample that was kept in foil during the 168 hours released 12.4 mg of silver ion per gram of sample into 98 grams of distilled water and 2.96 grams of sodium nitrate. The average total silver content was 14000 mg Ag/kg sample. The silver metal content was 800 mg/kg sample.

TABLE II-16
Example II-16 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 75.30 | 76.89 | 77.09 |
| 2 | 12% | in foil | 75.53 | 77.17 | 77.28 |
| 4 | 11% | in foil | 75.87 | 77.46 | 77.74 |
| 8 | 12% | in foil | 75.16 | 76.77 | 77.10 |
| 24 | 11% | in foil | 76.30 | 77.97 | 78.73 |
| 48 | 10% | in foil | 75.58 | 77.21 | 77.59 |
| 120 | 16% | in foil | 75.33 | 76.89 | 77.04 |
| 168 | 18% | in foil | 75.80 | 77.43 | 77.55 |
| 0 | 12% | exposed | 78.27 | 79.89 | 77.61 |
| 2 | 12% | exposed | 78.33 | 80.04 | 79.92 |
| 4 | 11% | exposed | 78.53 | 80.12 | 79.39 |
| 8 | 12% | exposed | 79.66 | 81.14 | 80.07 |
| 24 | 11% | exposed | 74.36 | 75.23 | 71.10 |
| 48 | 10% | exposed | 73.10 | 73.56 | 70.26 |
| 120 | 16% | exposed | 58.89 | 59.01 | 52.31 |
| 168 | 18% | exposed | 52.66 | 52.83 | 45.66 |
| 0 | 49% | exposed | 74.12 | 75.65 | 75.08 |
| 2 | 49% | exposed | 72.31 | 73.65 | 71.54 |
| 4 | 49% | exposed | 70.98 | 71.96 | 69.21 |
| 8 | 48% | exposed | 67.24 | 67.78 | 64.11 |
| 24 | 47% | exposed | 52.12 | 52.61 | 49.25 |
| 48 | 47% | exposed | 38.39 | 39.49 | 36.00 |
| 120 | 47% | exposed | 25.21 | 25.63 | 19.53 |
| 168 | 47% | exposed | 22.44 | 22.83 | 16.78 |

### Example II-17

Samples were prepared in same way as Example II-1, except the silver nitrate solution was prepared by placing 1.261 g silver nitrate and 200 g distilled water in a glass bottle. This resulting silver nitrate solution was approximately 4000 micrograms (μ) Ag per gram (g). The color of the samples was initially off-white and developed gray areas (splotchy) upon exposure to light. The results from color monitoring experiments are shown in Table II-17.

Silver ion release and total silver content measurements were conducted as described in Example II-1. An amount of 0.1360 g of the sample that was exposed to light for 168 hr at approximately 20% relative humidity released 35.35 mg silver ion per gram of sample within 30 minutes of placing the sample in 98 grams distilled water and 2.96 grams of 5M sodium nitrate. By comparison, a 0.1211 g sample that was kept in foil during the 168 hours released 27.37 mg of silver ion per gram of sample into 98 grams of distilled water and 2.96 grams of sodium nitrate. The average total silver content was 28,500 mg Ag/kg sample. The silver metal content was 1400 mg/kg sample.

TABLE II-17
Example II-17 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 73.87 | 75.46 | 77.48 |
| 2 | 12% | in foil | 74.13 | 75.74 | 73.98 |
| 4 | 11% | in foil | 73.94 | 75.51 | 73.60 |
| 8 | 12% | in foil | 74.10 | 75.70 | 74.11 |
| 24 | 11% | in foil | 72.79 | 74.40 | 72.92 |
| 48 | 10% | in foil | 73.89 | 75.53 | 74.38 |
| 120 | 16% | in foil | 73.97 | 75.47 | 73.60 |
| 168 | 18% | in foil | 73.62 | 75.24 | 73.63 |
| 0 | 12% | exposed | 78.92 | 80.55 | 78.70 |
| 2 | 12% | exposed | 78.39 | 79.88 | 78.74 |
| 4 | 11% | exposed | 77.15 | 78.53 | 78.78 |
| 8 | 12% | exposed | 75.16 | 76.30 | 76.56 |
| 24 | 11% | exposed | 70.52 | 70.80 | 68.93 |
| 48 | 10% | exposed | 61.48 | 61.39 | 61.30 |
| 120 | 16% | exposed | 48.40 | 48.93 | 48.63 |
| 168 | 18% | exposed | 40.41 | 41.29 | 38.73 |
| 0 | 49% | exposed | 70.91 | 72.59 | 72.84 |
| 2 | 49% | exposed | 68.15 | 69.45 | 64.16 |
| 4 | 49% | exposed | 66.20 | 67.07 | 61.32 |
| 8 | 48% | exposed | 59.62 | 59.83 | 54.12 |
| 24 | 47% | exposed | 39.81 | 40.26 | 36.05 |
| 48 | 47% | exposed | 29.03 | 29.81 | 25.12 |
| 120 | 47% | exposed | 13.65 | 13.63 | 9.97 |
| 168 | 47% | exposed | 11.48 | 11.34 | 8.12 |

### Example II-18

Samples were prepared in same way as Example II-16, except the drying temperature was 130° C. The color of the samples was light yellow. The results from color monitoring experiments are shown in Table II-18.

Silver ion release and total silver content measurements were conducted as described in Example II-1. An amount of 0.1423 g of the sample that was exposed to light for 168 hr at approximately 20% relative humidity released 14.81 mg silver ion per gram of sample within 30 minutes of placing the sample in 98 grams distilled water and 2.96 grams of 5M sodium nitrate. By comparison, a 0.1411 g sample that was kept in foil during the 168 hours released 10.36 mg of silver ion per gram of sample into 98 grams of distilled water and 2.96 grams of sodium nitrate. The average total silver content was 13,000 mg Ag/kg sample. The silver metal content was 970 mg/kg sample.

TABLE II-18
Example II-18 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 52.98 | 52.55 | 33.91 |
| 2 | 12% | in foil | 53.68 | 53.29 | 34.27 |
| 4 | 11% | in foil | 53.97 | 53.62 | 34.95 |
| 8 | 12% | in foil | 53.93 | 53.55 | 34.48 |
| 24 | 11% | in foil | 54.27 | 53.95 | 34.88 |
| 48 | 10% | in foil | 54.07 | 53.70 | 34.80 |
| 120 | 16% | in foil | 53.75 | 53.48 | 34.58 |
| 168 | 18% | in foil | 54.24 | 53.96 | 35.00 |
| 0 | 12% | exposed | 50.45 | 49.86 | 32.06 |
| 2 | 12% | exposed | 50.71 | 50.18 | 32.60 |
| 4 | 11% | exposed | 50.68 | 50.08 | 31.95 |
| 8 | 12% | exposed | 50.91 | 50.25 | 31.91 |
| 24 | 11% | exposed | 49.39 | 48.48 | 30.70 |
| 48 | 10% | exposed | 45.79 | 44.69 | 28.71 |
| 120 | 16% | exposed | 39.41 | 38.17 | 24.11 |
| 168 | 18% | exposed | 33.36 | 32.65 | 22.80 |
| 0 | 49% | exposed | 53.06 | 52.68 | 33.77 |
| 2 | 49% | exposed | 53.01 | 52.53 | 32.24 |
| 4 | 49% | exposed | 52.24 | 51.67 | 31.74 |
| 8 | 48% | exposed | 50.41 | 49.52 | 29.69 |
| 24 | 47% | exposed | 40.06 | 39.17 | 24.68 |
| 48 | 47% | exposed | 31.50 | 31.52 | 20.68 |
| 120 | 47% | exposed | 21.56 | 21.28 | 13.80 |
| 168 | 47% | exposed | 19.77 | 19.22 | 12.06 |

### Example II-19

Samples were prepared in same way as Example II-17, except the drying temperature was 130° C. The color of the samples was non-uniform in that it was light yellow that contained irregular areas of gray/black giving it a slightly mottled appearance. The results from color monitoring experiments are shown in Table II-19.

Silver ion release and total silver content measurements were conducted as described in Example II-1. An amount of 0.1176 g of the sample that was exposed to light for 168 hr at approximately 20% relative humidity released 35.25 mg silver ion per gram of sample within 30 minutes of placing the sample in 98 grams distilled water and 2.96 grams of 5M sodium nitrate. By comparison, a 0.1313 g sample that was kept in foil during the 168 hours released 24.93 mg of silver ion per gram of sample into 98 grams of distilled water and 2.96 grams of sodium nitrate. The average total silver content was 28,000 mg Ag/kg sample. The silver metal content was 1500 mg/kg sample.

TABLE II-19
Example II-19 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 51.51 | 51.71 | 35.49 |
| 2 | 12% | in foil | 50.74 | 51.04 | 35.16 |
| 4 | 11% | in foil | 52.00 | 52.29 | 35.94 |
| 8 | 12% | in foil | 51.99 | 52.35 | 36.25 |
| 24 | 11% | in foil | 51.20 | 51.50 | 35.58 |
| 48 | 10% | in foil | 52.60 | 53.00 | 36.81 |
| 120 | 16% | in foil | 50.97 | 51.30 | 35.56 |
| 168 | 18% | in foil | 52.41 | 52.82 | 36.30 |
| 0 | 12% | exposed | 50.84 | 50.82 | 35.60 |
| 2 | 12% | exposed | 51.31 | 51.21 | 35.54 |
| 4 | 11% | exposed | 50.89 | 50.89 | 35.24 |
| 8 | 12% | exposed | 51.18 | 51.01 | 35.12 |
| 24 | 11% | exposed | 48.48 | 48.39 | 34.79 |
| 48 | 10% | exposed | 47.16 | 46.46 | 31.66 |
| 120 | 16% | exposed | 39.85 | 39.05 | 27.42 |
| 168 | 18% | exposed | 35.81 | 35.16 | 23.92 |
| 0 | 49% | exposed | 49.81 | 49.68 | 33.88 |
| 2 | 49% | exposed | 49.12 | 48.88 | 31.87 |
| 4 | 49% | exposed | 48.67 | 48.29 | 31.3 |
| 8 | 48% | exposed | 46.65 | 46.07 | 29.81 |
| 24 | 47% | exposed | 37.12 | 36.61 | 24.49 |
| 48 | 47% | exposed | 29.08 | 28.96 | 19.63 |
| 120 | 47% | exposed | 21.56 | 21.28 | 13.80 |
| 168 | 47% | exposed | 19.77 | 19.22 | 12.06 |

### Example II-20

Samples were prepared in same way as Example II-19, except the drying temperature was 155° C. The color of the samples was non-uniform in that it was a darker golden yellow on one side by comparison to the other side. The lighter side was tested for color and those results are shown in Table II-20.

Silver ion release and total silver content measurements were conducted as described in Example II-1. An amount of 0.1358 g of the sample that was exposed to light for 168 hr at approximately 20% relative humidity released 26.32 mg silver ion per gram of sample within 30 minutes of placing the sample in 98 grams distilled water and 2.96 grams of 5M sodium nitrate. By comparison, a 0.1395 g sample that was kept in foil during the 168 hours released 18.21 mg of silver ion per gram of sample into 98 grams of distilled water and 2.96 grams of sodium nitrate. The average total silver content was 27,500 mg Ag/kg sample. The silver metal content was 3100 mg/kg sample.

TABLE II-20
Example II-20 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 37.03 | 36.21 | 17.70 |
| 2 | 12% | in foil | 37.95 | 37.09 | 17.57 |
| 4 | 11% | in foil | 37.08 | 36.22 | 17.62 |
| 8 | 12% | in foil | 37.19 | 36.31 | 17.84 |
| 24 | 11% | in foil | 37.41 | 36.57 | 17.89 |
| 48 | 10% | in foil | 37.49 | 36.66 | 17.89 |
| 120 | 16% | in foil | 37.77 | 36.96 | 18.29 |
| 168 | 18% | in foil | 37.96 | 37.19 | 18.36 |
| 0 | 12% | exposed | 36.99 | 35.89 | 17.15 |
| 2 | 12% | exposed | 37.00 | 35.89 | 17.66 |
| 4 | 11% | exposed | 37.10 | 36.02 | 17.63 |
| 8 | 12% | exposed | 37.45 | 36.22 | 16.96 |
| 24 | 11% | exposed | 36.27 | 35.08 | 17.48 |
| 48 | 10% | exposed | 36.04 | 34.73 | 16.60 |
| 120 | 16% | exposed | 34.11 | 32.62 | 15.21 |
| 168 | 18% | exposed | 32.21 | 30.61 | 14.38 |
| 0 | 49% | exposed | 38.82 | 38.1 | 19.16 |
| 2 | 49% | exposed | 39.06 | 38.42 | 18.93 |
| 4 | 49% | exposed | 38.71 | 38.04 | 18.97 |
| 8 | 48% | exposed | 37.95 | 37.13 | 18.08 |
| 24 | 47% | exposed | 36.74 | 35.63 | 16.78 |
| 48 | 47% | exposed | 32.61 | 31.27 | 14.58 |
| 120 | 47% | exposed | 23.56 | 21.15 | 9.79 |
| 168 | 47% | exposed | 19.31 | 16.92 | 8.47 |

### Example II-21

Samples were prepared in same way as Example II-1, except the drying temperature was 180° C. The color of the samples was golden yellow. The results from color monitoring experiments are shown in Table II-21.

Silver ion release and total silver content measurements were conducted as described in Example II-1. An amount of 0.1405 g of the sample that was exposed to light for 168 hr at approximately 20% relative humidity released 0.10 mg silver ion per gram of sample within 30 minutes of placing the sample in 98 grams distilled water and 2.96 grams of 5M sodium nitrate. By comparison, a 0.1371 g sample that was kept in foil during the 168 hours released 0.52 mg of silver ion per gram of sample into 98 grams of distilled water and 2.96 grams of sodium nitrate. The average total silver content was 1850 mg Ag/kg sample. The silver metal content was 450 mg/kg sample.

TABLE II-21
Example II-21 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 50.36 | 50.05 | 20.82 |
| 2 | 12% | in foil | 51.67 | 51.46 | 21.91 |
| 4 | 11% | in foil | 49.33 | 48.86 | 20.45 |
| 8 | 12% | in foil | 49.29 | 48.79 | 20.46 |
| 24 | 11% | in foil | 49.98 | 49.52 | 20.58 |
| 48 | 10% | in foil | 50.08 | 49.59 | 20.57 |
| 120 | 16% | in foil | 49.38 | 48.71 | 20.35 |
| 168 | 18% | in foil | 49.74 | 49.16 | 20.33 |
| 0 | 12% | exposed | 52.53 | 52.7 | 24.77 |
| 2 | 12% | exposed | 52.67 | 52.83 | 24.91 |
| 4 | 11% | exposed | 52.89 | 53.06 | 25.05 |
| 8 | 12% | exposed | 52.51 | 52.66 | 24.93 |
| 24 | 11% | exposed | 52.61 | 52.73 | 25.15 |
| 48 | 10% | exposed | 52.36 | 52.42 | 25.14 |
| 120 | 16% | exposed | 51.86 | 51.9 | 25.09 |
| 168 | 18% | exposed | 50.87 | 50.94 | 24.79 |
| 0 | 49% | exposed | 48.59 | 48.20 | 20.93 |
| 2 | 49% | exposed | 47.66 | 46.93 | 19.51 |
| 4 | 49% | exposed | 47.71 | 47.03 | 19.80 |
| 8 | 48% | exposed | 46.40 | 45.63 | 18.90 |
| 24 | 47% | exposed | 46.19 | 45.48 | 19.32 |
| 48 | 47% | exposed | 43.95 | 43.16 | 18.58 |
| 120 | 47% | exposed | 41.76 | 41.21 | 18.86 |
| 168 | 47% | exposed | 40.21 | 29.71 | 18.06 |

### Example II-22

Samples were prepared in same way as Example II-16, except the drying temperature was 180° C. The color of the samples was dark golden yellow. The results from color monitoring experiments are shown in Table II-22.

Silver ion release and total silver content measurements were conducted as described in Example II-1. An amount of 0.1364 g of the sample that was exposed to light for 168 hr at approximately 20% relative humidity released 0.80 mg silver ion per gram of sample within 30 minutes of placing the sample in 98 grams distilled water and 2.96 grams of 5M sodium nitrate. By comparison, a 0.1340 g sample that was kept in foil during the 168 hours released 1.88 mg of silver ion per gram of sample into 98 grams of distilled water and 2.96 grams of sodium nitrate. The average total silver content was 16000 mg Ag/kg sample. The silver metal content was 2700 mg/kg sample.

TABLE II-22
Example II-22 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 24.67 | 23.32 | 10.12 |
| 2 | 12% | in foil | 24.74 | 23.36 | 10.25 |
| 4 | 11% | in foil | 24.53 | 23.01 | 8.67 |
| 8 | 12% | in foil | 24.89 | 23.48 | 10.08 |
| 24 | 11% | in foil | 25.33 | 23.94 | 10.77 |
| 48 | 10% | in foil | 25.27 | 23.77 | 10.58 |
| 120 | 16% | in foil | 25.43 | 23.92 | 10.47 |
| 168 | 18% | in foil | 25.01 | 23.45 | 10.15 |
| 0 | 12% | exposed | 21.93 | 20.16 | 8.52 |
| 2 | 12% | exposed | 21.38 | 20.13 | 8.75 |
| 4 | 11% | exposed | 20.28 | 18.97 | 8.62 |
| 8 | 12% | exposed | 19.67 | 18.37 | 8.31 |
| 24 | 11% | exposed | 19.97 | 18.6 | 8.09 |
| 48 | 10% | exposed | 19.89 | 18.52 | 8.11 |
| 120 | 16% | exposed | 18.76 | 17.38 | 7.46 |
| 168 | 18% | exposed | 19.21 | 17.93 | 8.42 |
| 0 | 49% | exposed | 25.39 | 24.21 | 8.56 |
| 2 | 49% | exposed | 27.09 | 25.73 | 8.55 |
| 4 | 49% | exposed | 26.13 | 24.77 | 8.20 |
| 8 | 48% | exposed | 25.32 | 23.98 | 8.15 |
| 24 | 47% | exposed | 25.71 | 24.47 | 8.26 |
| 48 | 47% | exposed | 23.98 | 22.67 | 8.03 |
| 120 | 47% | exposed | 26.62 | 25.52 | 8.75 |
| 168 | 47% | exposed | 26.23 | 25.16 | 8.86 |

### Example II-23

Samples were prepared in same way as Example II-17, except the drying temperature was 180° C. The color of the samples was dark brown with black portions giving it the appearance of a burnt brown color. The results from color monitoring experiments are shown in Table II-23.

Silver ion release and total silver content measurements were conducted as described in Example II-1. An amount of 0.1443 g of the sample that was exposed to light for 168 hr at approximately 20% relative humidity released 1.50 mg silver ion per gram of sample within 30 minutes of placing the sample in 98 grams distilled water and 2.96 grams of 5M sodium nitrate. By comparison, a 0.1496 g sample that was kept in foil during the 168 hours released 3.30 mg of silver ion per gram of sample into 98 grams of distilled water and 2.96 grams of sodium nitrate. The average total silver content was 27500 mg Ag/kg sample. The silver metal content was 7500 mg/kg sample.

TABLE II-23
Example II-23 Color with Time

| Exposure | Relative | | CIE | | |
|---|---|---|---|---|---|
| Time | Humidity | Exposure | Tristimulus Values | | |
| (hr) | (% RH) | conditions | X | Y | Z |
| 0 | 12% | in foil | 15.23 | 14.06 | 8.20 |
| 2 | 12% | in foil | 14.81 | 13.56 | 7.38 |
| 4 | 11% | in foil | 15.30 | 14.00 | 7.72 |
| 8 | 12% | in foil | 15.28 | 13.97 | 7.64 |
| 24 | 11% | in foil | 15.48 | 14.19 | 8.01 |
| 48 | 10% | in foil | 15.42 | 14.16 | 8.22 |
| 120 | 16% | in foil | 15.24 | 13.88 | 7.51 |
| 168 | 18% | in foil | 15.61 | 14.30 | 8.13 |
| 0 | 12% | exposed | 14.32 | 13.09 | 6.35 |
| 2 | 12% | exposed | 15.14 | 13.96 | 7.40 |
| 4 | 11% | exposed | 15.02 | 13.89 | 8.06 |
| 8 | 12% | exposed | 15.05 | 13.82 | 7.27 |
| 24 | 11% | exposed | 15.25 | 14.03 | 7.40 |
| 48 | 10% | exposed | 14.37 | 13.29 | 8.21 |
| 120 | 16% | exposed | 15.14 | 13.90 | 7.02 |
| 168 | 18% | exposed | 14.63 | 13.54 | 7.64 |
| 0 | 49% | exposed | 15.16 | 13.88 | 7.12 |
| 2 | 49% | exposed | 14.98 | 13.57 | 6.67 |
| 4 | 49% | exposed | 15.07 | 13.63 | 6.48 |
| 8 | 48% | exposed | 15.90 | 14.46 | 7.15 |
| 24 | 47% | exposed | 15.75 | 14.41 | 7.29 |
| 48 | 47% | exposed | 14.94 | 13.64 | 6.67 |
| 120 | 47% | exposed | 15.12 | 13.86 | 7.18 |
| 168 | 47% | exposed | 14.30 | 13.03 | 6.45 |

### Example II-24

Samples were prepared in same way as Example II-10, except the drying temperature was 130° C. The color of the samples was light yellow. The results from color monitoring experiments are shown in Table II-24.

Silver ion release and total silver content measurements were conducted as described in Example II-1. An amount of 0.1385 g of the sample that was exposed to light for 168 hr at approximately 20% relative humidity released 0.84 mg silver ion per gram of sample within 30 minutes of placing the sample in 98 grams distilled water and 2.96 grams of 5M sodium nitrate. By comparison, a 0.1286 g sample that was kept in foil during the 168 hours released 1.93 mg of silver ion per gram of sample into 98 grams of distilled water and 2.96 grams of sodium nitrate. The average total silver content was 3750 mg Ag/kg sample.

TABLE II-24
Example II-24 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 49.48 | 48.61 | 29.17 |
| 2 | 12% | in foil | 49.51 | 48.61 | 29.56 |
| 4 | 11% | in foil | 49.87 | 48.99 | 29.80 |
| 8 | 12% | in foil | 49.47 | 48.55 | 29.76 |
| 24 | 11% | in foil | 49.55 | 48.55 | 29.99 |
| 48 | 10% | in foil | 49.65 | 48.72 | 29.84 |
| 120 | 16% | in foil | 49.56 | 48.57 | 30.69 |
| 168 | 18% | in foil | 49.92 | 49.02 | 30.48 |
| 0 | 12% | exposed | 53.26 | 52.83 | 34.06 |
| 2 | 12% | exposed | 53.38 | 52.95 | 34.29 |
| 4 | 11% | exposed | 52.99 | 52.62 | 33.81 |
| 8 | 12% | exposed | 52.60 | 52.34 | 33.43 |
| 24 | 11% | exposed | 51.75 | 51.51 | 32.31 |
| 48 | 10% | exposed | 51.74 | 51.48 | 32.42 |
| 120 | 16% | exposed | 50.66 | 50.08 | 29.90 |
| 168 | 18% | exposed | 48.19 | 47.37 | 26.87 |
| 0 | 49% | exposed | 50.77 | 50.14 | 31.19 |
| 2 | 49% | exposed | 49.79 | 48.88 | 29.28 |
| 4 | 49% | exposed | 49.91 | 48.91 | 29.29 |
| 8 | 48% | exposed | 49.92 | 48.88 | 28.65 |
| 24 | 47% | exposed | 46.59 | 45.05 | 26.48 |
| 48 | 47% | exposed | 43.36 | 42.00 | 24.19 |
| 120 | 47% | exposed | 35.83 | 34.86 | 20.96 |
| 168 | 47% | exposed | 35.53 | 34.47 | 20.33 |

### Example II-25

Samples were prepared in same way as Example II-11, except the drying temperature was 130° C. The color of the samples was yellow tan. The results from color monitoring experiments are shown in Table II-25.

Silver ion release and total silver content measurements were conducted as described in Example II-1. An amount of 0.1377 g of the sample that was exposed to light for 168 hr at approximately 20% relative humidity released 3.14 mg silver ion per gram of sample within 30 minutes of placing the sample in 98 grams distilled water and 2.96 grams of 5M sodium nitrate. By comparison, a 0.1540 g sample that was kept in foil during the 168 hours released 4.01 mg of silver ion per gram of sample into 98 grams of distilled water and 2.96 grams of sodium nitrate. The average total silver content was 6850 mg Ag/kg sample.

TABLE II-25
Example II-25 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 40.28 | 38.41 | 20.89 |
| 2 | 12% | in foil | 40.30 | 38.40 | 20.89 |
| 4 | 11% | in foil | 40.49 | 38.61 | 21.11 |
| 8 | 12% | in foil | 40.58 | 38.68 | 21.09 |
| 24 | 11% | in foil | 40.40 | 38.53 | 21.16 |
| 48 | 10% | in foil | 40.70 | 38.81 | 21.25 |
| 120 | 16% | in foil | 40.77 | 38.93 | 21.35 |
| 168 | 18% | in foil | 40.95 | 39.12 | 21.51 |
| 0 | 12% | exposed | 37.92 | 35.71 | 19.87 |
| 2 | 12% | exposed | 37.55 | 35.41 | 19.68 |
| 4 | 11% | exposed | 37.83 | 35.7 | 20.14 |
| 8 | 12% | exposed | 37.38 | 35.33 | 20.07 |
| 24 | 11% | exposed | 36.37 | 34.48 | 19.59 |
| 48 | 10% | exposed | 35.85 | 33.92 | 19.08 |
| 120 | 16% | exposed | 34.22 | 32.05 | 18.15 |
| 168 | 18% | exposed | 32.83 | 30.7 | 16.99 |
| 0 | 49% | exposed | 41.09 | 39.20 | 21.26 |
| 2 | 49% | exposed | 40.12 | 37.98 | 19.59 |
| 4 | 49% | exposed | 39.82 | 37.54 | 19.26 |
| 8 | 48% | exposed | 39.04 | 36.71 | 18.93 |
| 24 | 47% | exposed | 37.79 | 35.21 | 17.71 |
| 48 | 47% | exposed | 34.82 | 32.16 | 16.40 |
| 120 | 47% | exposed | 26.52 | 24.84 | 13.52 |
| 168 | 47% | exposed | 28.89 | 23.58 | 13.31 |

### Example II-26

Samples were prepared in same way as Example II-8, except the substrate was a non-woven of 100% TENCEL fibers (SX-152, white, 65 gsm, 24 mesh, from Green Bay Nonwovens, Inc. in Green Bay, Wis.) that contained less than 40 ppm chloride. The color of the samples was golden yellow. The results from color monitoring experiments are shown in Table II-26.

Silver ion release and total silver content measurements were conducted as described in Example II-1. An amount of 0.1902 g of the sample that was exposed to light for 168 hr at approximately 20% relative humidity released 2.19 mg silver ion per gram of sample within 30 minutes of placing the sample in 98 grams distilled water and 2.96 grams of 5M sodium nitrate. By comparison, a 0.1931 g sample that was kept in foil during the 168 hours released 2.87 mg of silver ion per gram of sample into 98 grams of distilled water and 2.96 grams of sodium nitrate. The average total silver content was 7350 mg Ag/kg sample.

TABLE II-26
Example II-26 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 25.87 | 23.52 | 6.56 |
| 2 | 12% | in foil | 26.24 | 23.87 | 6.69 |
| 4 | 11% | in foil | 26.43 | 24.05 | 6.76 |
| 8 | 12% | in foil | 26.11 | 23.77 | 6.70 |
| 24 | 11% | in foil | 26.08 | 23.74 | 6.77 |
| 48 | 10% | in foil | 26.45 | 24.06 | 6.71 |
| 120 | 16% | in foil | 26.61 | 24.20 | 6.70 |
| 168 | 18% | in foil | 26.97 | 24.50 | 6.69 |
| 0 | 12% | exposed | 26.29 | 23.91 | 7.06 |
| 2 | 12% | exposed | 25.01 | 22.67 | 6.35 |
| 4 | 11% | exposed | 25.43 | 23.19 | 6.76 |
| 8 | 12% | exposed | 25.79 | 23.57 | 7.01 |
| 24 | 11% | exposed | 24.65 | 22.66 | 6.75 |
| 48 | 10% | exposed | 24.02 | 22.24 | 6.90 |
| 120 | 16% | exposed | 21.62 | 20.28 | 6.62 |
| 168 | 18% | exposed | 21.35 | 20.19 | 6.89 |
| 0 | 49% | exposed | 26.03 | 23.70 | 6.96 |
| 2 | 49% | exposed | 25.31 | 23.24 | 6.65 |
| 4 | 49% | exposed | 24.56 | 22.73 | 6.79 |
| 8 | 48% | exposed | 23.39 | 21.83 | 6.82 |
| 24 | 47% | exposed | 21.17 | 20.31 | 7.38 |
| 48 | 47% | exposed | 19.46 | 19.15 | 7.82 |
| 120 | 47% | exposed | 18.81 | 18.93 | 9.41 |
| 168 | 47% | exposed | 19.06 | 19.30 | 10.53 |

### Example II-27

Samples were prepared in same way as Example II-8, except the substrate was a non-woven of 70% LYOCELL fibers/30% PET (SX-156, white, 50 gsm, FT-10 apertured, from Ahlstrom Green Bay, Inc. in Green Bay, Wis.) that contained less than 40 ppm chloride. The color of the samples was golden yellow. The results from color monitoring experiments are shown in Table II-27.

Silver ion release and total silver content measurements were conducted as described in Example II-1. An amount of 0.1608 g of the sample that was exposed to light for 168 hours (hr) at approximately 20% relative humidity released 2.99 mg silver ion per gram of sample within 30 minutes of placing the sample in 98 grams distilled water and 2.96 grams of 5M sodium nitrate. By comparison, a 0.1515 g sample that was kept in foil during the 168 hours released 6.53 mg of silver ion per gram of sample into 98 grams of distilled water and 2.96 grams of sodium nitrate. The average total silver content was 8450 mg Ag/kg sample.

TABLE II-27
Example II-27 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 12% | in foil | 37.89 | 36.07 | 13.51 |
| 2 | 12% | in foil | 38.35 | 36.52 | 13.90 |
| 4 | 11% | in foil | 38.39 | 36.59 | 13.97 |
| 8 | 12% | in foil | 37.93 | 36.11 | 13.38 |
| 24 | 11% | in foil | 38.47 | 36.66 | 13.93 |
| 48 | 10% | in foil | 38.01 | 36.15 | 13.20 |
| 120 | 16% | in foil | 38.91 | 37.08 | 14.10 |
| 168 | 18% | in foil | 39.18 | 37.33 | 14.01 |
| 0 | 12% | exposed | 39.10 | 37.42 | 14.55 |
| 2 | 12% | exposed | 35.30 | 34.09 | 14.17 |
| 4 | 11% | exposed | 34.49 | 33.64 | 14.74 |
| 8 | 12% | exposed | 31.97 | 31.33 | 13.88 |
| 24 | 11% | exposed | 29.08 | 28.92 | 13.94 |
| 48 | 10% | exposed | 25.77 | 25.81 | 13.32 |
| 120 | 16% | exposed | 22.25 | 22.60 | 12.58 |
| 168 | 18% | exposed | 20.82 | 21.41 | 13.62 |
| 0 | 49% | exposed | 39.77 | 38.03 | 15.23 |
| 2 | 49% | exposed | 34.17 | 33.34 | 15.14 |
| 4 | 49% | exposed | 29.05 | 28.56 | 13.57 |
| 8 | 48% | exposed | 26.53 | 26.61 | 14.47 |
| 24 | 47% | exposed | 22.57 | 23.18 | 15.47 |
| 48 | 47% | exposed | 22.06 | 22.72 | 17.23 |
| 120 | 47% | exposed | 20.75 | 21.17 | 17.60 |
| 168 | 47% | exposed | 22.96 | 23.32 | 20.73 |

### Example II-28

### Comparative

Samples were prepared in same way as Example II-4, except the drying temperature was 80° C. The initial color of the samples was off white. The results from color monitoring experiments are shown in Table II-28.

TABLE II-28
Example II-28 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 90.11 | 92.05 | 103.38 |
| 2 | 28% | in foil | 88.36 | 90.24 | 100.54 |
| 4 | 28% | in foil | 89.33 | 91.28 | 101.61 |
| 8 | 28% | in foil | 89.45 | 91.36 | 101.37 |
| 24 | 28% | in foil | 87.69 | 89.60 | 98.82 |
| 0 | 28% | exposed | 89.91 | 91.83 | 102.77 |
| 2 | 28% | exposed | 81.82 | 82.87 | 91.87 |
| 4 | 28% | exposed | 74.05 | 74.31 | 81.64 |
| 8 | 28% | exposed | 64.83 | 64.22 | 67.01 |
| 24 | 28% | exposed | 44.04 | 43.82 | 45.43 |
| 0 | 50% | exposed | 91.11 | 93.06 | 105.01 |
| 2 | 50% | exposed | 84.35 | 85.39 | 94.23 |
| 4 | 50% | exposed | 76.12 | 76.24 | 81.43 |
| 8 | 50% | exposed | 57.88 | 56.99 | 57.51 |
| 24 | 50% | exposed | 36.17 | 36.59 | 35.92 |

### Example II-29

### Comparative

Samples were prepared in same way as Example II-11, except the drying temperature was 80° C. The initial color of the samples was off white. The results from color monitoring experiments are shown in Table II-29.

TABLE II-29
Example II-29 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 88.51 | 90.40 | 98.82 |
| 2 | 28% | in foil | 87.96 | 89.84 | 97.60 |
| 4 | 28% | in foil | 88.26 | 90.13 | 97.57 |
| 8 | 28% | in foil | 88.29 | 90.18 | 97.03 |
| 24 | 28% | in foil | 86.37 | 88.27 | 93.35 |
| 0 | 28% | exposed | 90.06 | 91.99 | 102.55 |
| 2 | 28% | exposed | 86.96 | 88.49 | 97.45 |
| 4 | 28% | exposed | 83.47 | 84.56 | 92.26 |
| 8 | 28% | exposed | 75.28 | 75.27 | 79.70 |
| 24 | 28% | exposed | 54.60 | 54.14 | 56.55 |
| 0 | 50% | exposed | 88.58 | 90.47 | 99.23 |
| 2 | 50% | exposed | 82.85 | 83.98 | 90.29 |
| 4 | 50% | exposed | 75.59 | 75.77 | 81.13 |
| 8 | 50% | exposed | 60.09 | 59.35 | 62.85 |
| 24 | 50% | exposed | 34.42 | 35.74 | 37.87 |

### Example II-30

### Comparative

Samples were prepared in same way as Example II-28, except the substrate was a non-woven of 70% Viscose/30% PET fibers (507030RPET P1, white, 50 gsm, from FA-MA JERSEY S.p.A. of Italy). The initial color of the samples was off white. The results from color monitoring experiments are shown in Table II-30.

TABLE II-30
Example II-30 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 81.37 | 82.74 | 86.19 |
| 2 | 28% | in foil | 80.15 | 81.31 | 84.22 |
| 4 | 28% | in foil | 81.30 | 82.52 | 86.23 |
| 8 | 28% | in foil | 80.10 | 81.18 | 84.08 |
| 24 | 28% | in foil | 78.68 | 79.73 | 82.21 |
| 0 | 28% | exposed | 84.09 | 85.69 | 90.95 |
| 2 | 28% | exposed | 40.47 | 41.03 | 45.52 |
| 4 | 28% | exposed | 34.16 | 34.53 | 38.44 |
| 8 | 28% | exposed | 27.04 | 27.02 | 29.61 |
| 24 | 28% | exposed | 22.53 | 22.32 | 23.17 |
| 0 | 50% | exposed | 83.47 | 84.96 | 88.89 |
| 2 | 50% | exposed | 36.60 | 36.75 | 40.03 |
| 4 | 50% | exposed | 30.65 | 30.61 | 33.06 |
| 8 | 50% | exposed | 24.80 | 24.51 | 24.75 |
| 24 | 50% | exposed | 19.87 | 19.56 | 16.79 |

### Example II-31

### Comparative

Samples were prepared in same way as Example II-29, except the substrate was a non-woven of 70% Viscose/30% PET fibers (507030RPET P1, white, 50 gsm, from FA-MA JERSEY S.p.A. of Italy). The initial color of the samples was off white. The results from color monitoring experiments are shown in Table II-31.

TABLE II-31
Example II-31 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 83.81 | 85.50 | 89.18 |
| 2 | 28% | in foil | 83.26 | 84.89 | 88.50 |
| 4 | 28% | in foil | 83.92 | 85.59 | 89.66 |
| 8 | 28% | in foil | 82.67 | 84.25 | 87.58 |
| 24 | 28% | in foil | 81.72 | 83.42 | 86.21 |
| 0 | 28% | exposed | 85.94 | 87.80 | 92.68 |
| 2 | 28% | exposed | 50.71 | 51.40 | 58.32 |
| 4 | 28% | exposed | 42.69 | 43.07 | 48.42 |
| 8 | 28% | exposed | 32.40 | 31.80 | 33.98 |
| 24 | 28% | exposed | 24.65 | 24.29 | 24.94 |
| 0 | 50% | exposed | 84.83 | 86.65 | 90.38 |
| 2 | 50% | exposed | 45.73 | 46.53 | 51.53 |
| 4 | 50% | exposed | 37.08 | 37.04 | 39.38 |
| 8 | 50% | exposed | 28.42 | 27.50 | 26.63 |
| 24 | 50% | exposed | 19.13 | 17.95 | 14.25 |

### Example II-32

### Comparative

Samples were prepared in same way as Example II-27, except the drying temperature was 80° C. The initial color of the samples was off white. The results from color monitoring experiments are shown in Table II-32.

TABLE II-32
Example II-32 (Comparative) Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 82.78 | 83.66 | 90.59 |
| 2 | 28% | in foil | 82.40 | 83.23 | 90.07 |
| 4 | 28% | in foil | 82.70 | 83.49 | 90.27 |
| 8 | 28% | in foil | 82.50 | 83.21 | 89.90 |
| 24 | 28% | in foil | 80.46 | 81.05 | 87.50 |
| 0 | 28% | exposed | 84.02 | 85.04 | 91.42 |
| 2 | 28% | exposed | 41.48 | 41.60 | 46.75 |
| 4 | 28% | exposed | 32.67 | 32.97 | 38.11 |
| 8 | 28% | exposed | 28.61 | 29.01 | 33.61 |
| 24 | 28% | exposed | 23.99 | 24.36 | 28.34 |
| 0 | 50% | exposed | 84.96 | 86.10 | 93.01 |
| 2 | 50% | exposed | 40.73 | 40.84 | 46.51 |
| 4 | 50% | exposed | 33.88 | 34.04 | 39.12 |
| 8 | 50% | exposed | 29.17 | 29.43 | 33.70 |
| 24 | 50% | exposed | 25.38 | 25.52 | 27.80 |

### Example II-33

Samples were prepared in same way as Example II-30, except the drying temperature was 155° C. The initial color of the samples was golden brown. The results from color monitoring experiments are shown in Table II-33.

TABLE II-33
Example II-33 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 26.03 | 24.03 | 9.53 |
| 2 | 28% | in foil | 25.72 | 23.77 | 9.42 |
| 4 | 28% | in foil | 25.69 | 23.77 | 9.46 |
| 8 | 28% | in foil | 25.77 | 23.87 | 9.16 |
| 24 | 28% | in foil | 26.48 | 24.47 | 9.62 |
| 0 | 28% | exposed | 27.95 | 25.92 | 8.87 |
| 2 | 28% | exposed | 25.83 | 24.13 | 8.88 |
| 4 | 28% | exposed | 24.13 | 22.58 | 8.67 |
| 8 | 28% | exposed | 21.78 | 20.62 | 8.59 |
| 24 | 28% | exposed | 18.66 | 18.03 | 8.31 |
| 0 | 50% | exposed | 25.77 | 23.92 | 8.58 |
| 2 | 50% | exposed | 24.15 | 22.54 | 8.41 |
| 4 | 50% | exposed | 22.97 | 21.47 | 8.38 |
| 8 | 50% | exposed | 20.79 | 19.59 | 8.18 |
| 24 | 50% | exposed | 17.63 | 16.97 | 7.64 |

### Example II-34

Samples were prepared in same way as Example II-31, except the drying temperature was 155° C. The initial color of the samples was golden brown. The results from color monitoring experiments are shown in Table II-34.

TABLE II-34
Example II-34 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 27.80 | 26.40 | 11.98 |
| 2 | 28% | in foil | 28.41 | 27.00 | 12.17 |
| 4 | 28% | in foil | 28.37 | 26.96 | 12.06 |
| 8 | 28% | in foil | 28.07 | 26.65 | 11.88 |
| 24 | 28% | in foil | 28.05 | 26.61 | 11.91 |
| 0 | 28% | exposed | 29.39 | 28.01 | 13.29 |
| 2 | 28% | exposed | 28.68 | 27.36 | 13.17 |
| 4 | 28% | exposed | 28.93 | 27.67 | 13.44 |
| 8 | 28% | exposed | 27.55 | 26.33 | 12.96 |
| 24 | 28% | exposed | 26.04 | 24.83 | 12.44 |
| 0 | 50% | exposed | 29.57 | 28.45 | 12.61 |
| 2 | 50% | exposed | 27.29 | 26.42 | 12.20 |
| 4 | 50% | exposed | 25.72 | 24.96 | 11.72 |
| 8 | 50% | exposed | 24.79 | 24.21 | 12.14 |
| 24 | 50% | exposed | 22.14 | 22.01 | 11.44 |

### Example II-35

Samples were prepared in same way as Example II-8, except the substrate was woven nylon fibers (SR-823-32x28, 60 gsm, from American Fiber and Finishing in Albemarle, N.C.). The initial color of the samples was brown. The results from color monitoring experiments are shown in Table II-35.

TABLE II-35
Example II-35 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 48.45 | 48.01 | 40.25 |
| 2 | 28% | in foil | 47.78 | 47.23 | 39.54 |
| 4 | 28% | in foil | 49.45 | 48.98 | 41.26 |
| 8 | 28% | in foil | 51.37 | 51.02 | 43.06 |
| 24 | 28% | in foil | 49.61 | 49.19 | 41.67 |
| 0 | 28% | exposed | 45.29 | 44.93 | 39.33 |
| 2 | 28% | exposed | 46.72 | 46.56 | 42.18 |
| 4 | 28% | exposed | 44.99 | 44.80 | 40.59 |
| 8 | 28% | exposed | 44.05 | 43.65 | 38.92 |
| 24 | 28% | exposed | 42.50 | 42.01 | 37.52 |
| 0 | 50% | exposed | 46.14 | 46.01 | 39.51 |
| 2 | 50% | exposed | 58.75 | 59.19 | 56.32 |
| 4 | 50% | exposed | 56.22 | 56.55 | 53.54 |
| 8 | 50% | exposed | 47.25 | 47.12 | 42.27 |
| 24 | 50% | exposed | 50.58 | 50.64 | 47.74 |

### Example II-36

Samples were prepared in same way as Example II-11, except the substrate was woven nylon fibers (SR-823-32x28, 60 gsm, from American Fiber and Finishing in Albemarle, N.C.). The initial color of the samples was brown. The results from color monitoring experiments are shown in Table II-36.

TABLE II-36
Example II-36 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 36.27 | 35.64 | 27.31 |
| 2 | 28% | in foil | 44.44 | 44.49 | 37.32 |
| 4 | 28% | in foil | 35.03 | 34.84 | 29.53 |
| 8 | 28% | in foil | 36.56 | 36.33 | 30.93 |
| 24 | 28% | in foil | 33.35 | 33.65 | 28.49 |
| 0 | 28% | exposed | 35.83 | 35.60 | 28.67 |
| 2 | 28% | exposed | 35.22 | 34.94 | 28.33 |
| 4 | 28% | exposed | 33.89 | 33.51 | 27.10 |
| 8 | 28% | exposed | 34.26 | 33.96 | 28.05 |
| 24 | 28% | exposed | 33.22 | 32.93 | 27.19 |
| 0 | 50% | exposed | 31.39 | 31.09 | 25.81 |
| 2 | 50% | exposed | 32.89 | 32.53 | 27.09 |
| 4 | 50% | exposed | 32.20 | 31.88 | 26.69 |
| 8 | 50% | exposed | 32.22 | 31.92 | 27.21 |
| 24 | 50% | exposed | 29.86 | 29.55 | 25.23 |

### Example II-37

Samples were prepared in same way as Example II-8, except the substrate was a membrane filter comprised of cellulose nitrate and cellulose acetate (0.22 μM filters, GSWP 047 00, available from Millipore in Billerica, Mass.). The initial color of the samples was light brown. The results from color monitoring experiments are shown in Table II-37.

TABLE II-37
Example II-37 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 52.70 | 53.08 | 43.49 |
| 2 | 28% | in foil | 50.38 | 50.72 | 41.49 |
| 4 | 28% | in foil | 53.88 | 54.26 | 44.62 |
| 8 | 28% | in foil | 50.92 | 51.35 | 41.98 |
| 24 | 28% | in foil | 48.23 | 48.58 | 39.78 |
| 0 | 28% | exposed | 47.75 | 48.06 | 41.09 |
| 2 | 28% | exposed | 47.95 | 48.23 | 40.67 |
| 4 | 28% | exposed | 46.68 | 46.97 | 39.67 |
| 8 | 28% | exposed | 48.14 | 48.36 | 40.63 |
| 24 | 28% | exposed | 47.60 | 47.90 | 40.14 |
| 0 | 50% | exposed | 35.99 | 35.72 | 29.34 |
| 2 | 50% | exposed | 37.17 | 36.71 | 30.12 |
| 4 | 50% | exposed | 35.95 | 35.53 | 29.08 |
| 8 | 50% | exposed | 40.81 | 40.07 | 32.55 |
| 24 | 50% | exposed | 34.63 | 34.17 | 27.51 |

### Example II-38

Samples were prepared in same way as Example II-11, except the substrate was a membrane filter comprised of cellulose nitrate and cellulose acetate (0.22 μM filters, GSWP 047 00, available from Millipore in Billerica, Mass.). The initial color of the samples was light brown. The results from color monitoring experiments are shown in Table II-38.

TABLE II-38
Example II-38 Color with Time

| Exposure | Relative | | CIE Tristimulus | | |
|---|---|---|---|---|---|
| Time | Humidity | Exposure | Values | | |
| (hr) | (% RH) | conditions | X | Y | Z |
| 0 | 28% | in foil | 48.08 | 48.44 | 46.63 |
| 2 | 28% | in foil | 46.75 | 47.11 | 45.86 |
| 4 | 28% | in foil | 44.59 | 44.96 | 45.32 |
| 8 | 28% | in foil | 46.32 | 46.63 | 45.72 |
| 24 | 28% | in foil | 44.24 | 44.58 | 44.62 |
| 0 | 28% | exposed | 57.66 | 57.96 | 55.63 |
| 2 | 28% | exposed | 55.49 | 55.78 | 53.51 |
| 4 | 28% | exposed | 56.39 | 56.66 | 54.42 |
| 8 | 28% | exposed | 52.69 | 52.98 | 51.03 |
| 24 | 28% | exposed | 53.82 | 54.07 | 52.28 |
| 0 | 50% | exposed | 53.64 | 53.91 | 50.99 |
| 2 | 50% | exposed | 46.59 | 46.92 | 45.26 |
| 4 | 50% | exposed | 51.65 | 51.91 | 49.15 |
| 8 | 50% | exposed | 52.03 | 52.34 | 49.42 |
| 24 | 50% | exposed | 50.82 | 51.14 | 48.69 |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method of making an antimicrobial article, comprising:
applying a silver composition to a substrate to provide a liquid coated substrate, the silver composition comprising a silver salt other than silver sulfate in a solvent, the silver composition comprising a stabilizing agent in an amount less than about 100 ppm;
the substrate comprising material selected from the group consisting of polyamide, polyester, polyacetate, polyacrylic, polyolefin, polyurethane, polyvinylchloride, polyvinyl alcohol, polycarbonate, polyvinylpyrrolidone, polylactic acid, ethylene-vinyl acetate, polystyrene, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramic and combinations of two or more of the foregoing; and
drying the liquid coated substrate to provide a color stable antimicrobial article comprising silver salt applied to the substrate.

2. The method of claim 1, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.

3. (canceled)

4. (canceled)

5. The method of claim 1, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.

6. The method of claim 1, wherein the substrate comprises polyolefin selected from the group consisting of polypropylene, polyethylene, ethylene propylene copolymers, ethylene butylene copolymers, and combinations of two or more of the foregoing.

7. (canceled)

8. (canceled)

9. (canceled)

10. The method of claim 1, wherein the silver composition comprises a stabilizing agent in an amount less than 50 ppm based on the total weight of the silver salt composition.

11. The method of claim 1, wherein the silver composition comprises no stabilizing agent.

12. The method of claim 1, wherein drying the liquid coated substrate is accomplished at room temperature.

13. The method of claim 1, wherein drying the liquid coated substrate is accomplished a temperature less than about 100° C.

14. The method of claim 1 wherein the color stable antimicrobial article comprises silver salt applied to the substrate with a concentration of silver on the substrate being less than about 40,000 mg Ag/kg substrate.

15. (canceled)

16. The method of claim 1 wherein the color stable antimicrobial article comprises silver salt applied to the substrate with a concentration of silver on the substrate being less than about 10,000 mg Ag/kg substrate.

17. An article, comprising:
a silver salt other than silver sulfate, the silver salt applied to a substrate; and
the substrate comprising material selected from the group consisting of polyamide, polyester, polyacetate, polyacrylic, polyolefin, polyurethane, polyvinylchloride, polyvinyl alcohol, polycarbonate, polyvinylpyrrolidone, polylactic acid, ethylene-vinyl acetate, polystyrene, cellulose acetate, polyacrylate, polyacrylamide, polyacrylonitrile, polyvinylidene difluoride, polytetrafluoroethylene, polyoxymethylene, polyvinyl ether, styrene-ethylenebutylene-styrene elastomer, styrene-butylene-styrene elastomer, styrene-isoprene-styrene elastomer, glass fiber, ceramic and combinations of two or more of the foregoing; and
wherein the article is antimicrobial and color stable.

18. The article of claim 17 wherein the silver salt is selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing.

19. The article of claim 18, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.

20. (canceled)

21. (canceled)

22. The article of claim 18, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.

23. (canceled)

24. (canceled)

25. The article of claim 17, wherein the concentration of silver on the substrate is less than about 40,000 mg Ag/kg substrate.

26. (canceled)

27. The article of claim 25, wherein the concentration of silver on the substrate is less than about 40,000 mg Ag/kg substrate.

28. (canceled)

29. (canceled)

30. The article of claim 17, wherein the concentration of a stabilizing agent is less than about 100 ppm, based on the total weight of the article.

31. The method of claim 49, wherein the silver composition to a substrate to provide a liquid coated substrate, the silver composition comprising a silver salt is selected from the group consisting of silver acetate, silver benzoate, silver carbonate, silver chloride, silver citrate, silver iodate, silver lactate, silver nitrate, silver nitrite, silver oxalate, silver phosphate, silver sulfadiazine, silver saccharinate, silver anthranilate, silver chlorite, silver fluosilicate, silver trihydrogen paraperiodate, silver hyponitrite, silver levunilate, silver myristate, silver palmitate, silver propionate, silver stearate, silver tartrate, mild silver protein, silver protein and combinations of two or more of the foregoing.

32-48. (canceled)

49. A method of making an antimicrobial article, comprising:
applying a silver composition to a substrate to provide a liquid coated substrate, the silver composition comprising a silver salt other than silver sulfate; and
heating the liquid coated substrate at a temperature sufficient to form silver metal from silver salt to provide a color stable antimicrobial article comprising silver metal nanoparticles and silver salt.

50. The method of claim 49, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.

51. (canceled)

52. (canceled)

53. The method of claim 49, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.

54. The method of claim 49, wherein the substrate comprises material selected from the group consisting of cellulosic material, nylon, polyamides, polyacetates, collagen, gelatin, polyacrylamide, natural rubber, alginates and combinations of two or more of the foregoing.

55. The method of claim 54, wherein the substrate also comprises material selected from the group consisting of polyesters, polyacrylics, polyolefins, polyurethanes, polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer, and combinations of two or more of the foregoing.

56. (canceled)

57. The method of claim 54, wherein the cellulosic material comprises absorbent carboxymethylated materials selected from the group consisting of carboxymethylated cotton, carboxymethylated cellulose, carboxymethylated solvent-spun cellulose fibers, and carboxymethylated rayon and combinations of two or more of the foregoing.

58. The method of claim 54, wherein the cellulosic material is selected from the group consisting of cotton, rayon, hemp, jute, bamboo fibers, cellulose acetate, carboxymethylated solvent-spun cellulose fibers and combinations of two or more of the foregoing.

59. (canceled)

60. The method of claim 49, wherein heating the liquid coated substrate is accomplished at a temperature within the range from about 95° C. to about 225° C.

61. (canceled)

62. (canceled)

63. The method of claim 60, wherein heating the liquid coated substrate is accomplished at a temperature within the range from about 130° C. to about 175° C.

64. The method of claim 49, wherein the silver salt solution comprises a stabilizing agent in an amount less than 100 ppm based on the total weight of the silver composition.

65. The method of claim 49, wherein the silver salt solution comprises no stabilizing agent.

66. The method of claim 49, wherein the antimicrobial article is color stable having a non-white color.

67-81. (canceled)

82. An article, comprising:
a silver metal and silver salt applied to a substrate, the silver salt comprising a silver salt other than silver sulfate.

83. The article of claim 82, wherein the silver salt is selected from the group consisting of silver acetate, silver benzoate, silver carbonate, silver chloride, silver citrate, silver lactate, silver nitrate, silver nitrite, silver chlorite, silver fluosilicate, silver trihydrogen paraperiodate, silver levunilate, silver propionate, silver tartrate, mild silver protein, silver protein and combinations of two or more of the foregoing.

84. (canceled)

85. (canceled)

86. The article of claim 82, wherein the silver salt is selected from the group consisting of silver iodate, silver oxalate, silver phosphate, silver sulfadiazine, silver saccharinate, silver anthranilate, silver hyponitrite, silver myristate, silver palmitate, silver stearate and combinations of two or more of the foregoing.

87. The article of claim 82, wherein the substrate comprises a material selected from the group consisting of cellulosic material, nylon, polyamides, polyacetates, collagen, gelatin, polyacrylamide, natural rubber, alginates and combinations of two or more of the foregoing.

88. The article of claim 87, wherein the substrate also comprises material selected from the group consisting of polyesters, polyacrylics, polyolefins, polyurethanes, polyvinylchloride, polystyrenes, fiberglass, ceramic fibers, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer and combinations of two or more of the foregoing.

89. (canceled)

90. The article of claim 87, wherein the cellulosic material comprise absorbent carboxymethylated materials selected from the group consisting of carboxymethylated cotton, carboxymethylated cellulose, carboxymethylated solvent-spun cellulose fibers, and carboxymethylated rayon and combinations of two or more of the foregoing.

91. The article of claim 87, wherein the cellulosic material is selected from the group consisting of cotton, rayon, hemp, jute, bamboo fibers, cellulose acetate, carboxymethylated solvent-spun cellulose fibers and combinations of two or more of the foregoing.

92. (canceled)

93. The article of claim 82, wherein the antimicrobial article is color stable having a non-white color.

94. The article of claim 82, wherein the concentration of silver on the substrate is less than about 40,000 mg Ag/kg substrate.

95. The article of claim 82, wherein the concentration of silver on the substrate is less than about 20,000 mg Ag/kg substrate.

96. The article of claim 82, wherein the concentration of silver on the substrate is less than about 10,000 mg Ag/kg substrate.
